(19) United States
(12) Patent Application Publication
(10) Pub. No.: US 2019/0124964 A1
(43) Pub. Date: May 2, 2019

(54) Method and Apparatus for Soaking Corn

(71) Applicant: Frito-Lay North America, Inc., Plano, TX (US)

(72) Inventors: Donald BERNARD, Frisco, TX (US); Roli GARG, Austin, TX (US); Alexander WARNING, Peekskill, NY (US)

(21) Appl. No.: 15/796,194

(22) Filed: Oct. 27, 2017

(51) Int. Cl. A23L 19/00; A23P 30/00

(52) U.S. Cl. CPC A23L 19/09; A23V 2002/00; A23P 30/00

(57) ABSTRACT

A method and system for soaking corn and providing masa made from the corn with reduced moisture variations. In one aspect, the method comprises several steps. A first step comprises introducing a first batch of corn and a second batch of corn into a soak tank, providing a combined batch of corn. A second step comprises recirculating water in the soak tank to reduce a spatial temperature gradient in the combined batch of corn. In a second aspect, the system comprises a soak tank, a recirculation conduit and a recirculation conveyor. The soak tank comprises: a top portion, bottom portion, sidewall, recirculation outlet, and recirculation inlet. The recirculation outlet provides a removed stream of water, and the recirculation inlet enables the removed stream of water to be reintroduced to the soak tank, providing recirculation water. The recirculation conduit provides fluid communication from the recirculation outlet to the recirculation inlet.

### BACKGROUND

### Technical Field

The present invention relates to soaking corn to provide the corn with a desired moisture concentration, within a specified tolerance, throughout the entire volume of the corn. For example, corn comprising an initial temperature gradient can be soaked in water in a soak tank. While the corn is soaking, controlled recirculation of the water in the soak tank can be used to reduce or minimize a spatial gradient in a moisture concentration of the corn.

### Background

Existing methods and systems for soaking corn to provide masa are unsatisfactory in some regards. For example, corn leaving a soak tank can have a moisture concentration that varies as the corn is discharged from the soak tank. When the variation in corn moisture concentration is too large, it can cause complications for downstream processing of the corn to form a masa. Advantageously, the inventors have discovered methods and systems that can help reduce or minimize the variation in the moisture concentration of corn discharged from a soak tank. Among other advantages, this can help provide better control over the quality of the masa product produced from soaked corn.

### SUMMARY OF THE INVENTION

In a first aspect, the present invention provides a method comprising several steps. A first step comprises introducing a first batch of corn into a soak tank. A second step comprises introducing a second batch of corn into the soak tank to provide a combined batch of corn. The combined batch of corn comprises: the first batch of corn and the second batch of corn; corn and water; a combined batch volume; and a spatial temperature gradient within the combined batch volume. A third step comprises removing at least some of the water from the soak tank to provide a removed stream of water. A fourth step comprises reintroducing the removed stream of water into the soak tank to provide recirculation water. The recirculation water reduces the spatial temperature gradient in the combined batch of corn. A fifth step comprises discharging the combined batch of corn from the soak tank after the corn of the combined batch of corn has absorbed water to provide soaked corn.

In a second aspect, the present invention provides a system comprising a soak tank, a recirculation conduit and a recirculation conveyor. The soak tank comprises: a top portion, a bottom portion, a sidewall, a recirculation outlet, and a recirculation inlet. The top portion comprises a top of the soak tank and an upper opening for introducing corn and water into the soak tank. The bottom portion comprises a bottom of the soak tank and a lower opening for discharging corn and water from the soak tank. The sidewall extends from the bottom portion to the top portion. The recirculation outlet provides a removed stream of water, and the recirculation inlet enables the removed stream of water to be reintroduced to the soak tank to provide recirculation water. The recirculation conduit provides fluid communication from the recirculation outlet to the recirculation inlet so the removed stream of water can be reintroduced to the soak tank through the recirculation inlet to provide the recirculation water. The recirculation conveyor is in fluid communication with the recirculation outlet and the recirculation inlet, and the recirculation conveyor is for conveying the removed stream of water to the recirculation inlet to provide the recirculation water.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic illustration of a system comprising a soak tank according to an embodiment of the invention.

FIG. 2 is a schematic illustration of a spatial temperature gradient throughout the volume of product in a soak tank.

FIG. 3 is a schematic illustration of a plurality of heaters for heating product in a soak tank.

FIG. 4 is a schematic illustration of a soak tank from which product is being discharged.

FIG. 5 is a schematic illustration of a washer for washing product discharged from the soak tank.

FIG. 6 is a schematic illustration of a mill for providing masa and a production process for making a masa product.

FIG. 7 is a schematic illustration of a screen for filtering particles from recirculation water.

FIG. 8 is a schematic flowchart illustrating a method for soaking a product according to an embodiment of the invention.

### DETAILED DESCRIPTION

In one aspect, the present invention can provide improved control over the moisture concentration of a product that is soaked in a liquid, for example, water. In developing the present invention, the inventors realized that existing soaking processes can result in different rates of liquid absorption for a product at differential spatial locations within the volume of a soak tank. For example, if product is placed into a soak tank from a plurality of product batches, the product batches can be at different temperatures. This can create a spatial temperature gradient in the soak tank, which can, in turn, result in different rates of liquid absorption for the product at different positions within the soak tank. Also, placing product batches in the soak tank at different times can also result in different moisture concentrations, even if the product batches are at the same temperature, because the rate of absorption of a liquid into a product can be related to the amount of liquid that a product has already absorbed.

Additionally, even if all the product placed in a soak tank is initially at a single common temperature, a spatial temperature gradient for the product in the soak tank can develop over time, for example, as a result of the product in one location of the soak tank cooling or heating at a different rate than the product at another location within the soak tank. The following examples help to illustrate this point. First, if a soak tank cools from the walls, for example, by losing heat to the atmosphere, a spatial temperature gradient can occur from inner portions of the soak tank towards a wall of the soak tank. Second, a soak tank that is not completely symmetric or that includes differing degrees of insulation can experience spatial temperature gradients due to the different rates of cooling associated with the physical configuration of the soak tank. Third, as a spatial temperature gradient develops in a soak tank, even if a soak tank were completely symmetric, the spatial temperature gradient can result in convection which can, in turn, contribute to further spatial temperature gradients from top to bottom or from the center to the outer regions in the soak tank.

As a result of a spatial temperature gradient in a soak tank, a spatial gradient in the liquid-absorption rate can also occur. Furthermore, a spatial gradient in the liquid-absorption rate can ultimately result in a spatial gradient in the moisture concentration for product throughout the volume of the soak tank and result in a changing moisture concentration for a discharge stream of the product when the product is discharged. The spatial moisture-concentration gradient at discharge can be significant, especially if the product is discharged from the soak tank before the product reaches equilibrium with respect to temperature and/or moisture concentration. Furthermore, as a result of a spatial moisture-concentration gradient when the product is discharged from the soak tank, the moisture concentration of the discharged product can vary over time as product from different locations within the soak tank is discharged.

Variations in the moisture concentration of discharged product over time can, in turn, lead to complications for downstream processes if a constant moisture concentration is preferable. For example, if the product in a soak tank is corn used for making masa, if the moisture concentration of the discharged product varies, then a masa product made from the discharged product can also have a moisture concentration that varies over time unless the moisture concentration is further controlled with additional equipment at additional costs. Moreover, if the moisture concentration of the masa is allowed to vary beyond an acceptable range, products (e.g., tortilla chips) made from the masa can have less desirable organoleptic properties with respect to taste, texture, and moisture concentration.

Advantageously, the inventors have discovered that complications associated with variations in the moisture concentration of a soaked product as it is discharged from a soak tank can be reduced, minimized or eliminated with an improved process for recirculating liquid in a soak tank. Although, this is one potential benefit of an inventive embodiment described herein, a skilled person with the benefit of the present disclosure would recognize that the apparatuses, systems and/or methods described herein can also provide additional or alternative advantages.

Also, a skilled person with the benefit of the present disclosure would recognize that the system and/or methods described herein can be advantageous relative to alternative systems and/or methods that attempt to reduce or minimize a moisture concentration gradient in a product in a soak tank. For example, compared to agitating corn directly with mechanical means (e.g., using an auger to agitate the corn or transferring the corn to an intermediate vessel before transferring the corn to a soak tank) recirculating the water in a soak tank can be used to reduce, minimize, or almost eliminate removal of corn hulls. In some embodiments, this can be advantageous to avoid too much moisture absorption and/or to provide a controlled degree of moisture absorption that does not vary between corn kernels in which the hull has been removed and corn kernels in which the hull has not been removed.

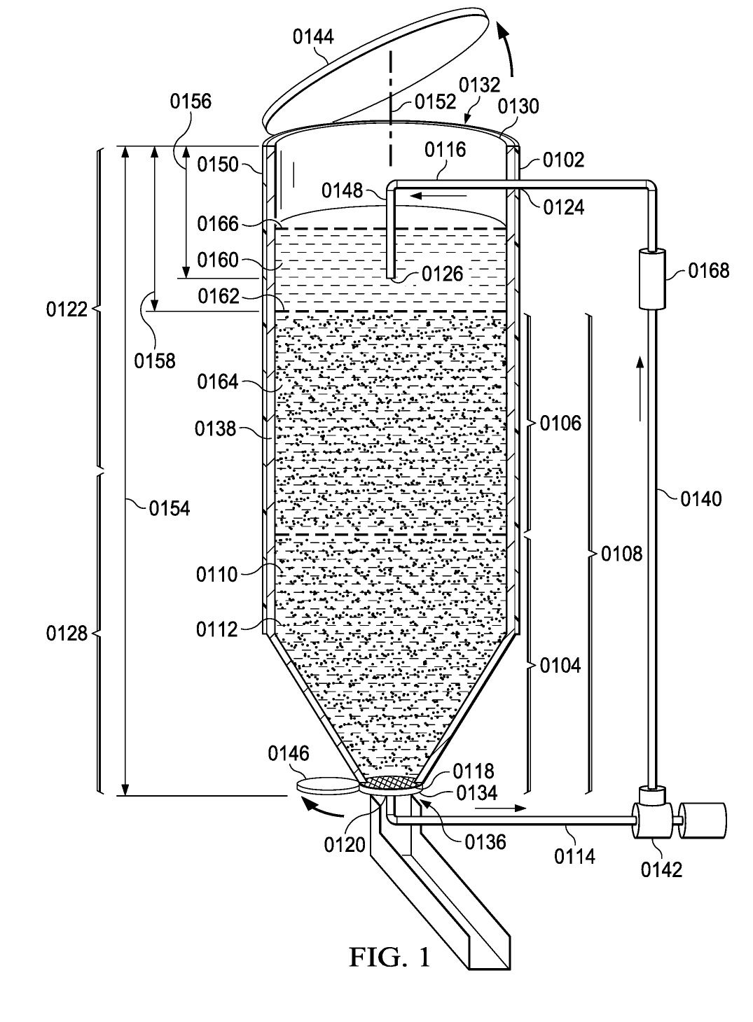

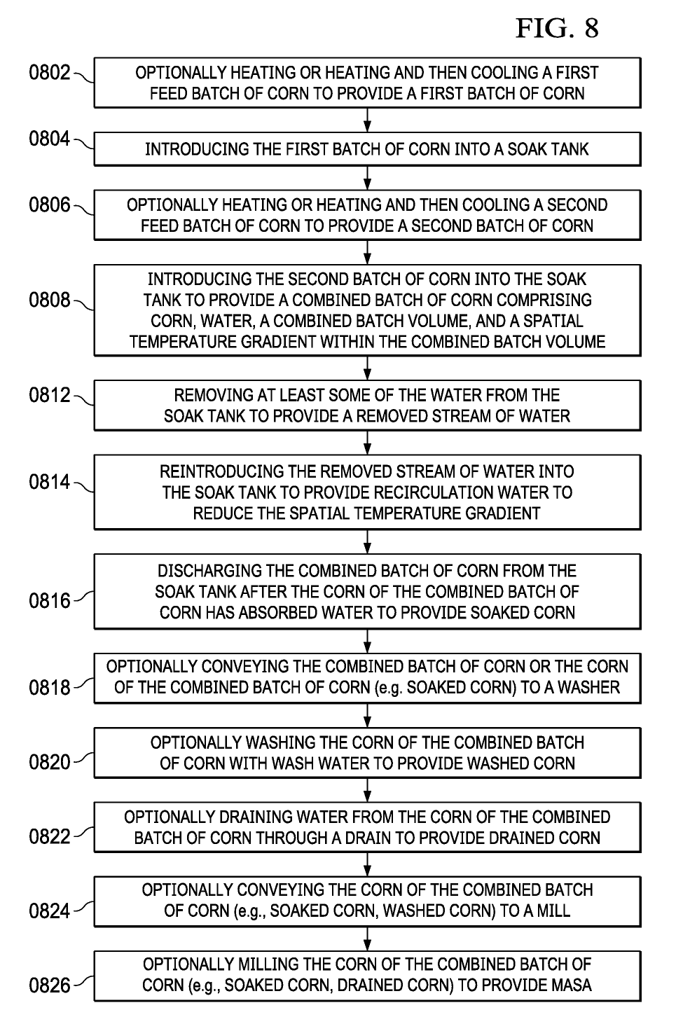

An embodiment of the invention will now be described with reference to FIG. 8, which provides a schematic flow chart illustrating one embodiment of a method for soaking corn. With respect to individual elements used in FIG. 8, it is also useful to reference FIG. 1, which provides an example of a soak tank 0102 and various associated elements.

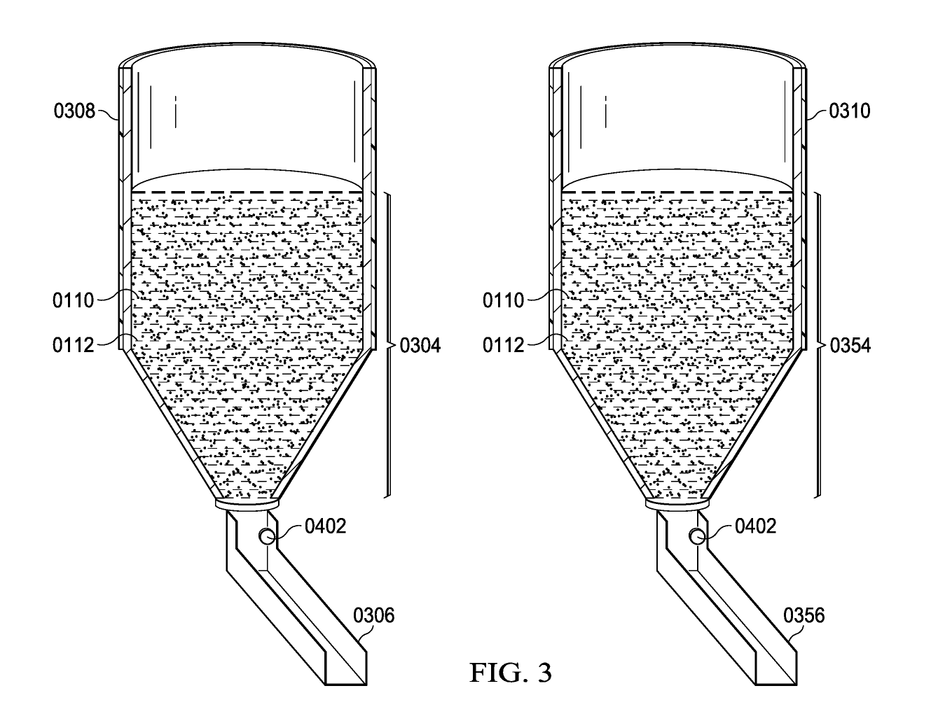

With reference to FIG. 8, first, an optional first-feed-batch-heating step 0802 comprises heating or heating and cooling a first feed batch of corn 0304, including any additional water in the first feed batch of corn 0304 (as illustrated in FIG. 3) to provide a first heated batch of corn. For example, the first heated batch of corn can be a first batch of corn 0104 that will be introduced into a soak tank 0102 (as illustrated in FIG. 1). The cooling can be used to reduce the temperature of the corn below a gelatinization temperature of the corn in the first feed batch of corn so that the gelatinization process stops. The cooling can be accomplished in any way that is convenient, for example, adding cooler water to the first heated batch of corn, refrigeration, recirculating the water through a heat exchanger to cool it, allowing natural cooling due to ambient heat loss, etc., or any combination thereof. In the interest of easily finding illustrations corresponding to the reference numbers described herein, it is noted that the first two numbers in the four digit reference numbers used to refer to elements in this disclosure generally refer to a figure number where the element can be found. For example, an illustration of an embodiment of a soak tank 0102 can be found in FIG. 1.

With reference again to FIG. 8, as a second step of the schematic flow chart, a first corn-introducing step 0804 comprises introducing the first batch of corn 0104 into the soak tank 0102.

Third, an optional second-feed-batch-heating step 0806 comprises heating or heating and cooling a second feed batch of corn 0354, including any added water in the second feed batch of corn 0354 to provide a second heated batch of corn. The second heated batch of corn can be a second batch of corn 0106 that will be introduced into the soak tank 0102, optionally, along with the water combined with the second feed batch of corn. The cooling can be used to reduce the temperature of the corn below a gelatinization temperature of the corn in the second feed batch of corn so that the gelatinization process stops. The cooling can be accomplished in any way that is convenient, for example, adding cooler water to the first heated batch of corn, refrigeration, recirculating the water through a heat exchanger to cool it, allowing natural cooling due to ambient heat loss, etc., or any combination thereof.

Fourth, a second corn-introducing step 0810 comprises introducing a second batch of corn 0106 (and optionally the water combined with the second batch of corn) into the soak tank 0102 to provide a combined batch of corn 0108. In some embodiments, the second batch of corn can be provided to the soak tank by a process that is the same as or similar to the process used for providing the first batch of corn to the soak tank. As illustrated in FIG. 1, the combined batch of corn 0108 comprises the first batch of corn 0104 and the second batch of corn 0106. Additionally, as illustrated, the first batch of corn 0104, the second batch of corn 0106, and the combined batch of corn 0108 each comprise corn 0110 and water 0112. However, in some embodiments, the first batch of corn and/or the second batch of corn can comprise, consist of, or consist essentially of corn and water inherent to the corn. If desired, additional water can be added to the soak tank.

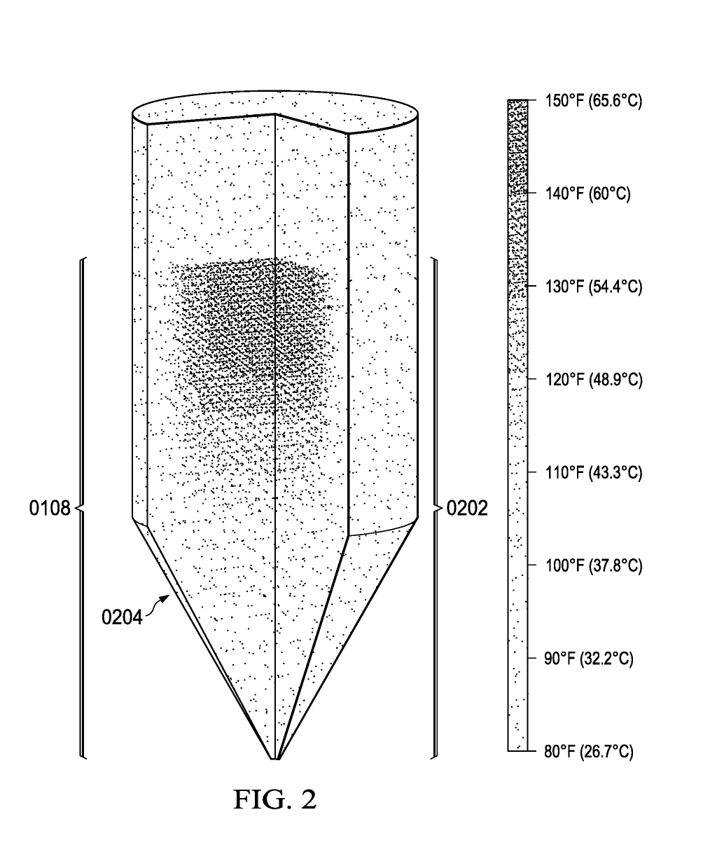

As illustrated in FIG. 2, at least when the first batch of corn 0104 and the second batch of corn 0106 are combined, the combined batch of corn 0108 has a combined batch volume 0202, and a spatial temperature gradient 0204 (e.g., first spatial temperature gradient) within the combined batch volume 0202. In the illustration of FIG. 2, product (e.g., corn) and liquid (e.g., water) at the inner portion of the soak tank (with denser or darker-appearing stippling) is at a relatively higher temperature while the product and water is at a relatively lower temperature (with less dense or lighter-appearing stippling) toward the walls or interior surface of the soak tank (e.g., sidewall 0138, bottom 0134, top 0130, any interior surface of the soak tank in contact with the product and/or liquid inside the soak tank, etc.). For example, the specific type of temperature gradient shown in FIG. 2 can occur when the combined batch of corn 0108 has been soaking for some time and has lost heat through the soak tank walls. Natural convection can also influence the temperature gradient in the soak tank. Other factors that can influence or cause a temperature gradient in a soak tank include adding the second batch of corn 0106 (e.g., at a second/higher temperature) on top of the first batch of corn 0104 (e.g., at a first/lower temperature). For example, the first batch of corn can be at a lower temperature than the second batch of corn if the first batch of corn has cooled before the second batch of corn is added to the soak tank.

Fifth, a water-removing step 0812 comprises removing at least some of the water from the soak tank 0102 to provide a removed stream of water 0114. With reference to FIG. 1, in some embodiments, the water-removing step 0812 comprises removing water from the soak tank 0102 at a bottom portion 0128 of the soak tank 0102, removing at least some of the water from the soak tank 0102 through a screen 0118, removing at least some of the water from the soak tank 0102 through a recirculation outlet 0120 of the soak tank 0102, or a combination thereof.

Sixth, a water-reintroducing step 0814 comprises reintroducing the removed stream of water 0114 into the soak tank 0102 to provide recirculation water 0116, which reduces or minimizes the spatial temperature gradient 0204 in the combined batch of corn 0108 (e.g., to provide a second spatial temperature gradient). In some embodiments, the water-reintroducing step 0814 comprises reintroducing the removed stream of water 0114 into the soak tank 0102 at a top portion 0122 of the soak tank 0102 (e.g., top half of the soak tank), reintroducing the removed stream of water 0114 into the soak tank 0102 though a recirculation inlet 0124 of the soak tank 0102, reintroducing the removed stream of water 0114 into the soak tank 0102 at a recirculation discharge location 0126, or a combination thereof. In some embodiments, the water-reintroducing step 0814 can begin after the second corn-introducing step 0810. Although, it is also possible to begin reintroducing the removed stream of water 0114 into the soak tank 0102 before the second corn-introducing step 0810.

Seventh, a combined-batch-discharging step 0816 comprises discharging the combined batch of corn 0108 from the soak tank 0102 after the corn of the combined batch of corn 0108 has absorbed water to provide soaked corn.

Eighth, an optional washer-feed-conveying step 0818 comprises conveying the combined batch of corn 0108 or the corn of the combined batch of corn 0108 (e.g., soaked corn) to a washer 0502 (e.g., tumbler) for washing the corn of the combined batch of corn 0108.

Ninth, an optional corn-washing step 0820 comprises washing the corn of the combined batch of corn 0108 with wash water 0504 to provide washed corn.

Tenth, optional draining step 0822 comprises draining water from the corn of the combined batch of corn 0108 through a drain 0506 to provide drained corn.

Eleventh, an optional soaked-corn-conveying step 0824 comprises conveying the corn from the combined batch of corn 0108 (e.g., soaked corn and/or washed corn) to a mill 0602.

Twelfth, an optional soaked-corn-milling step 0826 comprises milling the corn of the combined batch of corn 0108 (e.g., soaked corn, drained corn) to provide masa 0604.

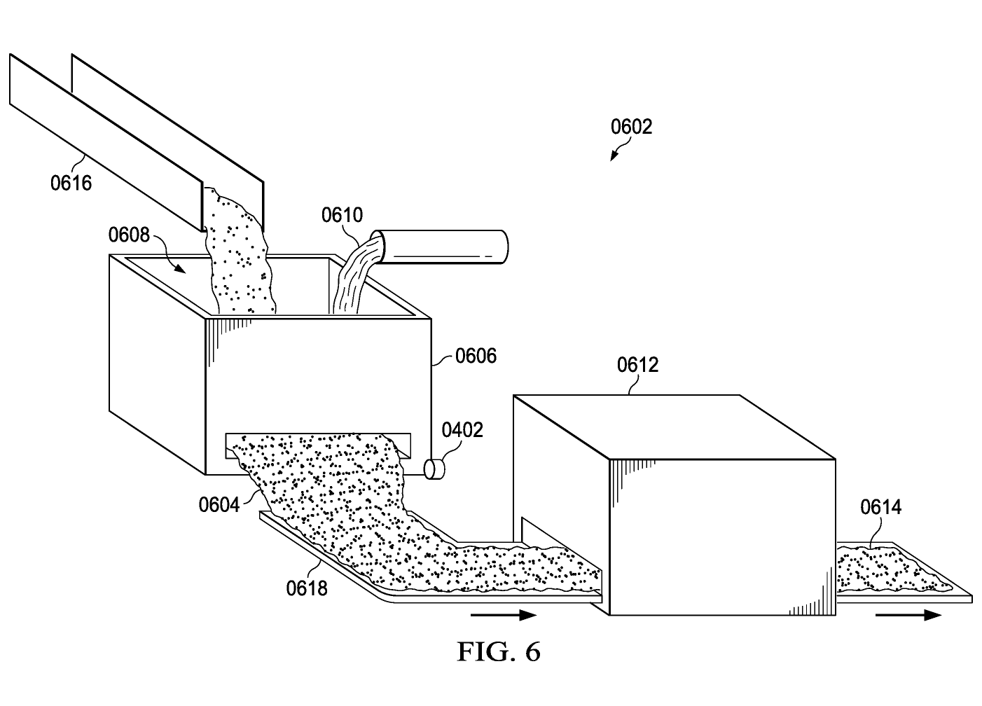

Thirteenth, although not specifically illustrated in FIG. 8, in a further optional step, the masa 0604 can be transferred to a production process 0612 for making a masa product 0614. An example is illustrated in FIG. 6.

With reference now to FIG. 3, the first-feed-batch-heating step 0802 can comprise heating or heating and cooling a first feed batch of corn 0304, and any added water in the first feed batch of corn 0304, to provide a first heated batch of corn, which can be the first batch of corn 0104 introduced into the soak tank 0102. For example, the first feed batch of corn 0304 can be heated from an ambient temperature, e.g., 25.0° C. (77.0° F.).

In some embodiments, the first batch of corn 0104 is heated to a first preliminary temperature that is equal to at least a gelatinization temperature of the corn (e.g., at least 150, 155, 160, 170, 180, 190, 200, 210° F. [65, 68, 71, 76, 82, 87, 93, 98° C.]) and to no more than a boiling temperature of water used to gelatinize the first heated batch of corn (e.g., 212° F. [100° C]). In some embodiments, the temperature of the first batch of corn is held at (e.g., within +/−20, 15, 10, 5, 4, 3, 2, or 1% of the preliminary temperature) or above this first preliminary temperature for more than 1, 2, 3, 4, 5, 6, 7, 8, 9, or 10 minutes. In some embodiments, the temperature of the first batch of corn is held at (e.g., within +/−20, 15, 10, 5, 4, 3, 2, or 1% of the preliminary temperature) or above the first preliminary temperature for 1-10, 1-9, 1-7, 1-6, 1-5, 1-4, 1-3, or 1-2 minutes. Then, in some embodiments the first batch of corn is cooled to a first preheat temperature (e.g., a mass-weighted bulk average temperature of the first batch of corn 0104) or first initial soak temperature selected from:
(a) no more than 145° F. (62.8° C.), 37.8 to 62.8° C. (100 to 145° F.), 43.3 to 62.8° C. (110 to 145° F.), 51.7 to 62.8° C. (125 to 145° F.), 51.7 to 54.4° C. (125 to 130° F.), or about 61.7° C. (143° F.);
(b) at least 37.8° C. (100° F.) and below a first gelatinization temperature at which starch in the corn will begin to gelatinize given a first batch preheat moisture concentration by weight of the corn of the first batch of corn 0104; and
(c) a combination thereof.

By cooling the first batch of corn below the gelatinization temperature, the gelatinization of the first batch of corn can be stopped (e.g., in a process called quenching). Furthermore, gelatinization of the corn, which can be controlled by varying the temperature of the first batch of corn and how long the first batch of corn spends at the temperature, affects moisture absorption of the corn in the first-feed-batch-heating step 0802 and in the soak tank. To determine whether or not a desired degree of gelatinization has occurred during the heating step, the degree of gelatinization can be measured directly or indirectly (for example, by measuring moisture content of the corn), as a skilled person would understand after reading this disclosure.

In some embodiments, at least 90, 95, 96, 97, 98, or 99% by weight of the first batch of corn 0104 is provided at, heated (or heated and cooled) to the first preheat temperature or first initial soak temperature. Additionally, the entire first batch of corn 0104 can be heated (or heated and cooled) to the first preheat temperature or first initial soak temperature.

In some embodiments, heating the first batch of corn 0104, and any added water included in the first batch of corn 0104, lasts no more than 0.9, 0.8, 0.7, 0.6 or 0.5 hours. In some embodiments, heating the first batch of corn 0104 lasts 0.9 to 0.3, 0.8 to 0.4, 0.7 to 0.4, 0.6 to 0.4 or about 0.5 hours. This can contribute to providing a quicker process for soaking the corn.

Moreover, in some embodiments of a method for soaking corn, the method comprises allowing the first batch of corn 0104 to cool to a first initial soak temperature and allowing the first batch of corn 0104 to absorb water to provide the first batch of corn 0104 with a first initial soak moisture concentration.

As illustrated in FIG. 3, in some embodiments, the first corn-introducing step 0804 comprises introducing a first heated batch of corn into the soak tank 0102 using a first soak tank feed conveyor 0306. The first soak tank feed conveyor 0306 can be or comprise a passive conveyor, an active conveyor, or a combination thereof. Examples of a passive conveyor include a chute, canal, duct, and pipe. Examples of an active conveyor include an auger, screw, paddles, endless conveyor belt, blower, compressor, and pump.

In some embodiments of the method for soaking corn, upon introducing the first batch of corn 0104 into the soak tank 0102, the first batch of corn 0104 has a first initial soak temperature. In some embodiments, the first initial soak temperature is equal to 37.8 to 62.8° C. (100 to 145° F.), 43.3 to 62.8° C. (110 to 145° F.), 51.7 to 62.8° C. (125 to 145° F.), 51.7 to 54.4° C. (125 to 130° F.), 48.9 to 60° C. (120 to 140° F.), or 48.9 to 54.4° C. (120 to 130° F.). In some embodiments, the first initial soak temperature is a mass-weighted bulk average temperature. In some embodiments, at least 90, 95, 96, 97, 98, 99% by weight of the first batch of corn 0104 can be heated to the first initial soak temperature. In some embodiments, the entire first batch of corn 0104 is heated to the first initial soak temperature.

In some embodiments of the method for soaking corn, upon introducing the first batch of corn 0104 into the soak tank 0102, the first batch of corn 0104 has a first initial soak moisture concentration by weight of 30 to 38%, 31 to 37%, 32 to 36%, 33 to 35%, or about 34%. The first initial soak moisture concentration of the first batch of corn 0104 includes any inherent moisture in the corn and excludes free water around the corn. In some embodiments, the first initial soak moisture concentration is measured using an online moisture concentration meter 0402, for example, as illustrated in FIG. 3. The online moisture concentration meter can be a meter with continuous monitoring capability, for example, a conductivity-based meter or infrared-based meter. However, as a skilled person would understand, even so-called continuous monitoring is often, in practice, periodic measuring with a small time interval between each measurement.

With reference again to FIG. 3, the second-feed-batch-heating step 0806 can comprise heating a second feed batch of corn 0354, including any added water in the second feed batch of corn, to provide a second heated batch of corn, which can be the second batch of corn 0106 introduced into the soak tank 0102.

In some embodiments, the second feed batch of corn 0354 is heated from ambient temperature, e.g., 25.0° C. (77.0° F.).

In some embodiments, the second batch of corn 0106 is heated to a second preliminary temperature that is equal to at least a gelatinization temperature of the corn (e.g., at least 150, 155, 160, 170, 180, 190, 200, 210° F. [65, 68, 71, 76, 82, 87, 93, 98° C.]) and to no more than a boiling temperature of water used to gelatinize the second heated batch of corn (e.g., 212° F. [100° C]). In some embodiments, the temperature of the second batch of corn is held at (e.g., within +/−20, 15, 10, 5, 4, 3, 2, or 1% of the preliminary temperature) or above this second preliminary temperature for more than 1, 2, 3, 4, 5, 6, 7, 8, 9 or 10 minutes. In some embodiments, the temperature of the second batch of corn is held at (e.g., within +/−20, 15, 10, 5, 4, 3, 2, or 1% of the preliminary temperature) or above the second preliminary temperature for 1-10, 1-9, 1-8, 1-7, 1-6, 1-5, 1-4, 1-3, or 1-2 minutes. Then, in some embodiments the second batch of corn is cooled to a second preheat temperature (e.g., a mass-weighted bulk average temperature of the second batch of corn 0106) or second initial soak temperature selected from:
(a) no more than 145° F. (62.8° C.), 37.8 to 62.8° C. (100 to 145° F.), 43.3 to 62.8° C. (110 to 145° F.), 51.7 to 62.8° C. (125 to 145° F.), 51.7 to 54.4° C. (125 to 130° F.), or about 61.7° C. (143° F.);
(b) at least 37.8° C. (100° F.) and below a second gelatinization temperature, which can be the same as the first gelatinization temperature, at which starch in the corn will begin to gelatinize given a second batch preheat moisture concentration by weight of the second batch of corn 0106; and
(c) a combination thereof.

By cooling the second batch of corn below the gelatinization temperature, the gelatinization of the second batch of corn can be stopped (e.g., in a process called quenching). Furthermore, gelatinization of the corn, which can be controlled by varying the temperature of the second batch of corn and how long the second batch of corn spends at the temperature, affects moisture absorption of the corn in the second-feed-batch-heating step 0806 and in the soak tank. To determine whether or not a desired degree of gelatinization has occurred during the heating step, the degree of gelatinization can be measured directly or indirectly (for example, by measuring moisture content of the corn), as a skilled person would understand after reading this disclosure.

In some embodiments, at least 90, 95, 96, 97, 98, or 99% by weight of the second batch of corn 0106 is provided at, heated (or heated and cooled) to the second preheat temperature or second initial soak temperature. In some embodiments, the entire second batch of corn 0106 is heated (or heated and cooled) to the second preheat temperature or second initial soak temperature.

In some embodiments, heating the second batch of corn 0106, and any added water included in the second batch of corn, lasts no more than 0.9, 0.8, 0.7, 0.6 or 0.5 hours or wherein the heating the second batch of corn 0106 lasts 0.9 to 0.3, 0.8 to 0.4, 0.7 to 0.4, 0.6 to 0.4 or about 0.5 hours. This can contribute to providing a quicker process for soaking the corn.

Moreover, in some embodiments of a method for soaking corn, the method comprises allowing the second batch of corn 0106 to cool to a second initial soak temperature, and allowing the second batch of corn 0106 to absorb water to provide the second batch of corn 0106 with a second initial soak moisture concentration.

As illustrated in FIG. 3, in some embodiments, the second corn-introducing step 0810 comprises introducing a second heated batch of corn into the soak tank 0102 using a second soak tank feed conveyor 0356. The second soak tank feed conveyor 0356 can be or comprise a passive conveyor, an active conveyor, or a combination thereof. As an example, the passive conveyor and the active conveyor can be any type of passive conveyor or active conveyor described herein, respectively.

In some embodiments, a second batch heater (or heater and cooler) 0308 for heating (or heating and cooling) a second feed batch of corn 0354 is a first batch heater (or heater and cooler) 0308 for heating a first feed batch of corn 0304. Although, in some embodiments the second batch heater (or heater and cooler) 0308 for heating (or heating and cooling) the second feed batch of corn 0354 and the first batch heater (or heater and cooler) 0308 for heating (or heating and cooling) the first feed batch of corn 0304 are different heaters. Additionally, in some embodiments, the second soak tank feed conveyor 0356 is the first soak tank feed conveyor 0306. Although, in some embodiments the second soak tank feed conveyor 0356 and the first soak tank feed conveyor 0306 are different conveyors.

In some embodiments of the method for soaking corn, upon introducing the second batch of corn 0106 into the soak tank 0102, the second batch of corn 0106 has a second initial soak temperature. In some embodiments, the second initial soak temperature is equal to 37.8 to 62.8° C. (100 to 145° F.), 43.3 to 62.8° C. (110 to 145° F.), 51.7 to 62.8° C. (125 to 145° F.), 51.7 to 54.4° C. (125 to 130° F.), 48.9 to 60° C. (120 to 140° F.), or 48.9 to 54.4° C. (120 to 130° F.). In some embodiments, the second initial soak temperature is a mass-weighted bulk average temperature. In some embodiments, at least 90, 95, 96, 97, 98, or 99% by weight of the second batch of corn 0106 can be heated to the second initial soak temperature. In some embodiments, the entire second batch of corn 0106 is heated to the second initial soak temperature.

In some embodiments of the method for soaking corn, upon the introducing the second batch of corn 0106 into the soak tank 0102, the second batch of corn 0106 has a second initial soak moisture concentration by weight of 30 to 38%, 31 to 37%, 32 to 36%, 33 to 35%, or about 34%. The second initial soak moisture concentration of the corn includes any inherent moisture in the corn and excludes free water around the corn. In some embodiments, the second initial soak moisture concentration is measured using an online moisture concentration meter 0402, for example, as illustrated in FIG. 3. The online moisture concentration meter can be a meter with continuous monitoring capability, for example, a conductivity-based meter or infrared-based meter.

With reference, for example, to FIG. 1 and FIG. 8, the water-reintroducing step 0814 can comprise recirculating a removed stream of water 0114 to provide recirculation water. In some embodiments, it can be advantageous to recirculate water from bottom-to-top of the soak tank, although other configurations such as bottom-to-side, top-to-bottom, top-to-side, side-to-bottom, and side-to-top recirculation are also contemplated. Bottom-to-top recirculation can be advantageous, for example, to more quickly reduce, minimize or eliminate the spatial temperature gradient in the soak tank for some configurations of the soak tank and its contents.

In some embodiments it can be advantageous to provide the recirculation tank with a soak tank heater (e.g., a recirculation water heater 0168). The soak tank heater can be used to provide and/or maintain the combined batch of corn in the soak tank at a desired temperature during soaking and/or at a desired temperature upon discharge from the soak tank. In some embodiments, the desired temperature is at least as high as a desired minimum temperature (e.g., 43.3° C. (110° F.)) and/or below a temperature that results in gelatinization of the corn under the soaking conditions for the corn. For example, the combined batch of corn can be provided and/or maintained at the first initial soak temperature range as described herein. Additionally, in some embodiments, the soak tank heater is a heating element, heating coil, heat exchanger, steam/hot water jacket, microwave heater/over, radio frequency (RF) heater/oven, ultrasound heater, infrared radiation emitter, etc. In some embodiments, the soak tank heater (e.g., recirculation water heater 0168) is positioned to heat recirculation water in or from the recirculation conduit before the recirculation water is reintroduced into the soak tank.

In some embodiments, it is useful to define a recirculation delay time as the time passing from the introducing the second batch of corn 0106 into the soak tank 0102 until the reintroducing the removed stream of water 0114 into the soak tank 0102 begins. Additionally, it can be useful to define a second batch delay time as the time passing from the introducing the first batch of corn 0104 into the soak tank 0102 until the introducing the second batch of corn 0106 into the soak tank 0102.

As an illustration, it can be useful to employ a recirculation delay time to postpone recirculation to a time after the second batch of corn 0106 has been introduced to the soak tank. For example, if the first batch of corn 0104 has already been absorbing water in the soak tank for 30 minutes when the second batch of corn 0106 is introduced into the soak tank, the corn in the first batch of corn 0104 could have absorbed more water than the corn in the second batch of corn 0106. However, if the corn in the first batch of corn 0104 has also cooled to a lower temperature than the corn in the second batch of corn 0106, the corn in the first batch of corn 0104 could be absorbing moisture at a slower rate than the corn in the second batch of corn 0106. If the corn in the first batch of corn 0104 has a relatively higher moisture concentration than the corn in the second batch of corn, the higher moisture concentration could also contribute to the corn in the first batch of corn absorbing moisture at a slower rate than the corn in the second batch of corn 0106. In order to reduce the differences in moisture concentration between the corn in the first batch of corn 0104 and the corn in the second batch of corn 0106, it can be advantageous to allow the differences in temperature between the first and second batch, and thus the difference in rates of absorption between the first and second batch, to persist for a time. Implementing a recirculation delay time can help to accomplish this objective.

In some embodiments, the method for soaking corn is further characterized by an element selected from the group of elements consisting of:
(i) the recirculation delay time is equal to the second batch delay time +/−50, 40, 30, 25, 20, 15, 10, 5, 4, 3, 2, or 1% of the second batch delay time;
(ii) the recirculation delay time is equal to at least 1.5, 1.4, 1.3, 1.25, 1.2, 1.15, 1.1, 1.05, 1.04, 1.03, 1.02 1.01, or 1 times the second batch delay time; and
(iii) a combination thereof.

In some embodiments of a method for soaking corn, the recirculation water 0116 is provided with a recirculation water flow rate. As an illustration, in some embodiments it can be advantageous to set the recirculation flow rate at a maximum value that avoids a potentially undesirable degree of disturbance to the corn in the soak tank (e.g., results in the removal of the hulls of the corn). If the spatial moisture concentration gradient associated with the corn in the soak tank has already been desirably reduced (e.g., minimized or even eliminated), then using a maximum recirculation flow rate can be advantageous to provide an equilibrium temperature (or even equal/consistent temperature) for all, essentially all, or most of the corn in the soak tank. This can, in turn, provide a more consistent (or even equal) rate of moisture absorption for the corn in the soak tank, and help maintain any progress achieved in reducing the moisture concentration gradient.

In some embodiments, the recirculation water flow rate can be at least 0.61, 0.46, 0.3, 0.15 m/s (2, 1.5, 1, 0.5 ft./s) or set to provide the recirculation water 0116 with a residence time equal to no more than and/or no less than 18, 17, 16, 15, 14, 13, 12, 11, 10, 9, 8, 7, 6, 5, 4, 3, 2, 1, 0.5, or 0.25 hours. For purposes of determining a recirculation water flow rate, the residence time can be calculated by dividing a recirculation water mass (e.g., mass of water in the soak tank 0102 available to act as recirculation water 0116) by a mass-based recirculation water flow rate of the recirculation water. Furthermore, the mass-based recirculation water flow rate can be determined from this relationship between the residence time and flow rate. Additionally, the density of the water can be used to convert the mass-based recirculation water flow rate to a volume-based recirculation water flow rate as desired.

In some embodiments the recirculation water flow rate is set so that the recirculation water flow rate does not result in turbulent conditions for the water in the soak tank 0102.

In some embodiments the recirculation water flow rate is set at a value selected from the group consisting of:
(a) no more than 1.5, 1.4, 1.3, 1.2, 1.1, 1.05, 1.04, 1.03, 1.02, 1.01 or 1.0 times a highest non-turbulent flow rate that avoids turbulent conditions for the water (e.g. water in a corn-bed-and-water-phase 0164) in the soak tank 0102;
(b) no less than 0.5, 0.6, 0.7, 0.8, 0.9, 0.95, 0.96, 0.97, 0.98, or 0.99 times a highest non-turbulent flow rate that avoids turbulent conditions for the water (e.g. water in a corn-bed-and-water-phase 0164) in the soak tank 0102;
(c) no more than 1.5, 1.4, 1.3, 1.2, 1.1, 1.05, 1.04, 1.03, 1.02, 1.01 or 1.0 times a highest laminar flow rate that provides laminar conditions for the water (e.g. water in a corn-bed-and-water-phase 0164) in the soak tank 0102;
(d) no less than 0.5, 0.6, 0.7, 0.8, 0.9, 0.95, 0.96, 0.97, 0.98, 0.99 or 1.0 times a highest laminar flow rate that provides laminar conditions for the water (e.g. water in a corn-bed-and-water-phase 0164) in the soak tank 0102;
(e) a limited-Reynolds-number flow rate that provides a Reynolds number for the water (e.g. water in a corn-bed-and-water-phase 0164) within the soak tank 0102 equal to no more than 1.0, 0.99, 0.98, 0.97, 0.96, 0.95, 0.9, 0.8, 0.7, 0.6 or 0.5 times 2300;
(f) a limited-Reynolds-number flow rate that provides a Reynolds number for the water (e.g. water in a corn-bed-and-water-phase 0164) within the soak tank 0102 equal to no more than 1.0, 0.99, 0.98, 0.97, 0.96, 0.95, 0.9, 0.8, 0.7, 0.6 or 0.5 times 2000;
(g) no more than 0.61, 0.46, 0.3, 0.15 m/s (2, 1.5, 1, 0.5 ft./s);
(h) no less than 0.61, 0.46, 0.3, 0.15 m/s (2, 1.5, 1, 0.5 ft./s); and
(i) a combination thereof.

In some embodiments of the method for soaking corn, it can be useful to define a recirculation delay time and/or second batch delay time, as previously discussed. Moreover, it can be useful to define a second-batch time that begins with introducing the second batch of corn 0106 into the soak tank 0102 and ends with discharging the combined batch of corn 0108 from the bottom portion 0128 of the soak tank 0102.

In some embodiments of the method for soaking corn, the recirculation delay time is equal to at least 1.5, 1.4, 1.3, 1.25, 1.2, 1.15, 1.1, 1.05, 1.04, 1.03, 1.02 1.01, or 1 times the second batch delay time.

In some embodiments, the recirculation water flow rate is set to provide the recirculation water 0116 with a desired residence time. The desired residence time can be selected from the group consisting of:
(i) no more than 2, 1.5, 1.25, 1.2, 1.15, 1.1, 1.05, 1, 0.95, 0.9, 0.8, 0.75, or 0.5 times the difference of the second-batch time minus the second batch delay time;
(ii) no more than 1.5, 1.4, 1.3, 1.2, 1.1, 1.0, 0.9, 0.8, 0.7, 0.6, or 0.5 times the second-batch time;
(iii) 1.5 to 0.5, 1.5 to 1.0, 1.0 to 0.5, 0.75 to 0.25 times the second-batch time;
(iv) the second-batch time +/−50%, 40%, 30%, 20%, 10%, 5%, 4%, 3%, 2%, or 1% of the second-batch time;
(v) 9-18, 10-17, 10-12, or 11 hours; and
(vi) a combination thereof.

With reference to FIG. 2, in some embodiments of the method for soaking corn, at an initial discharge time when the discharging the combined batch of corn 0108 begins, a standard deviation of the temperature for the combined batch of corn 0108 at each spatial position in the combined batch volume 0202 in the soak tank 0102 is no more than 8.3, 5.6, 5.0, 4.4, 3.9, 3.3, 2.8, 2.2, 1.7, 1.1, 0.6, or 0.47° C. (15, 10, 9, 8, 7, 6, 5, 4, 3, 2, 1, 0.85° F.).

This can be advantageous, for example, so that the moisture concentration of the corn discharged from the soak tank will not vary over time as corn from different positions in the soak tank is evacuated.

In some embodiments of the method for soaking corn, a mass-weighted bulk average temperature of the combined batch of corn 0108 leaving the soak tank 0102 is at least 37.8° C. (100° F.) or 43.3° C. (110° F.), or is 37.8 to 54.4° C. (100 to 130° F.), 37.8 to 48.9° C. (100 to 120° F.), 43.3 to 54.4° C. (110 to 130° F.), or 48.9 to 54.4° C. (120 to 130° F.).

In some embodiments, the combined batch of corn 0108 is discharged from the soak tank 0102 to provide a discharge stream 0404 of the combined batch of corn 0108. A combined batch discharge temperature of the discharge stream 0404 can be periodically measured to provide a plurality of periodic discharge temperature measurements. Examples of periodic discharge temperature measurements include measurements at regular intervals, such as 5, 4, 3, 2, or 1 minute intervals, or 30, 15, 10, 5, 4, 3, 2, or 1 second intervals. In some embodiments, the periodic discharge temperature measurements can cover a time period that encompasses the entire combined batch of corn 0108. In some embodiments, the combined batch discharge temperature is measured using a discharge temperature probe 0406. For example, the discharge temperature probe 0406 can be positioned to measure temperature at a stationary measurement point 0408 intersecting the discharge stream 0404 of the combined batch of corn 0108. In some embodiments, a standard deviation of the combined batch discharge temperature for all of the plurality of periodic discharge temperature measurements is no more than 8.3, 5.6, 5.0, 4.4, 3.9, 3.3, 2.8, 2.2, 1.7, 1.1, 0.6, or 0.47° C. (15, 10, 9, 8, 7, 6, 5, 4, 3, 2, 1, 0.85° F.). In some embodiments, the first 1, 2, 3, 4, or 5% by weight of the combined batch of corn 0108 to be discharged, the last 1, 2, 3, 4, or 5% by weight of the combined batch of corn 0108 to be discharged, or a combination thereof can be excluded from the plurality of periodic discharge temperature measurements for the purpose of calculating the standard deviation of the combined batch discharge temperature.

In some embodiments, the combined-batch-discharging step 0816 comprises discharging the combined batch of corn 0108 from a bottom portion 0128 of the soak tank 0102, for example, by opening the bottom portion 0128 of the soak tank 0102 to allow the combined batch of corn 0108 to exit the soak tank 0102 under a force of gravity.

In some embodiments, discharging the combined batch of corn 0108 begins 9 to 18, 10 to 17, 10 to 12 or about 11 hours after the introducing the second batch of corn 0106 into the soak tank 0102.

In some embodiments, discharging the combined batch of corn 0108 takes no more than 1.5, 1, 0.5, or 0.25 hours to discharge at least 99% by weight of the combined batch of corn 0108 in the soak tank 0102. In some embodiments, discharging the combined batch of corn 0108 takes about 0.25 to 1.5, 0.5 to 1, or 0.4 to 0.6 hours to discharge at least 99% by weight of the combined batch of corn 0108 in the soak tank 0102.

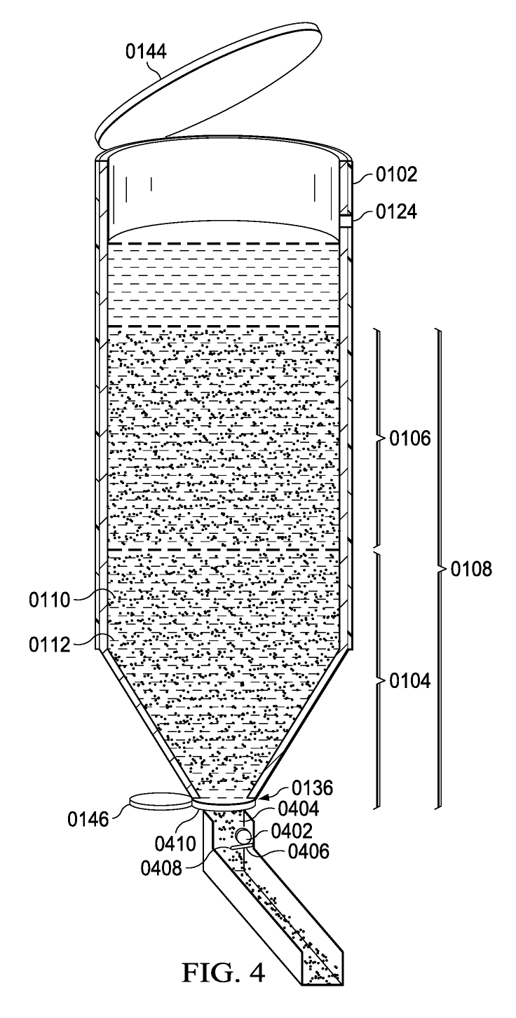

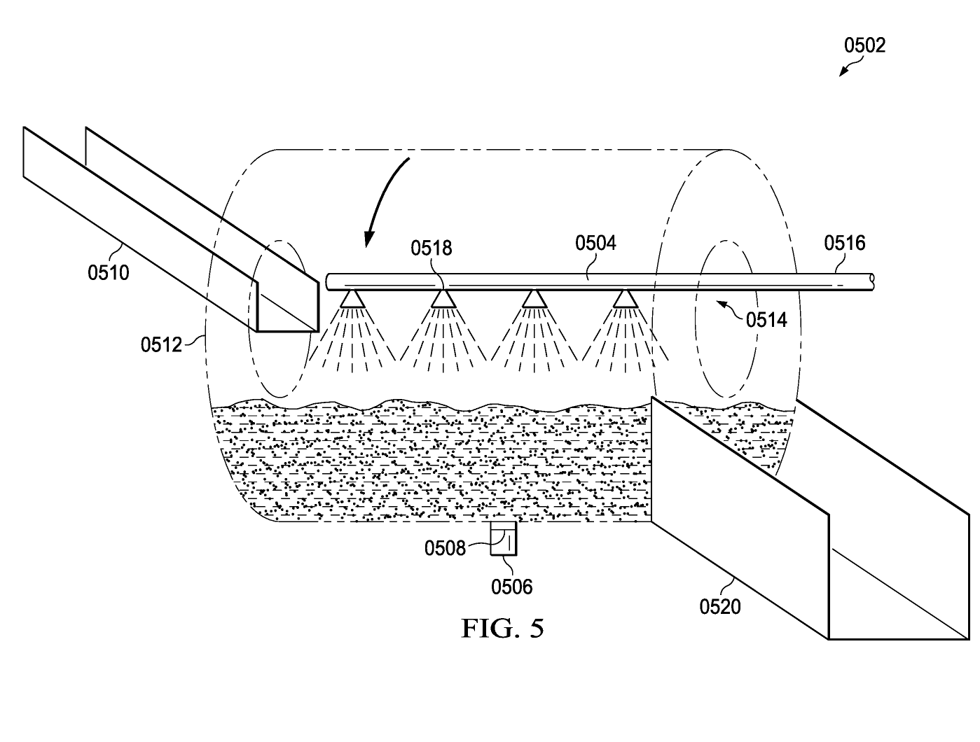

With reference to FIG. 1, FIG. 4 and FIG. 5, the washer-feed-conveying step 0818 comprises conveying the combined batch of corn 0108 or the corn of the combined batch of corn 0108 (e.g., soaked corn) to a washer 0502 (e.g., tumbler) for washing the corn of the combined batch of corn 0108.

With reference to FIG. 5, the corn-washing step 0820 comprises washing the corn of the combined batch of corn 0108 with wash water 0504 to provide washed corn. In some embodiments, the corn is washed using water that exits a conduit or nozzle at a high velocity, for example, a high enough velocity to dislodge hulls of the combined batch of corn. In some embodiments, the water is provided with sufficient velocity, momentum, kinetic energy, or a combination thereof to remove the hulls from the combined batch of corn upon contact with the combined batch of corn; however, the wash water has a sufficiently low velocity, momentum, kinetic energy or combination thereof to avoid breaking the corn kernels inside the hulls. For example, in some embodiments the wash water has a sufficiently low velocity, momentum, kinetic energy or combination thereof so that no more than 40, 30, 20, 10, 9, 8, 7, 6, 5, 4, 3, 2, or 1% by weight of the corn kernels are broken by the water to a size that is small enough to fit through a screen that is intended to pass the hulls of the corn but retain the corn kernels. As an example, the water can be provided with a high velocity if the wash water is supplied at high pressure (e.g., at least 50, 60, 70 80 or 90 psig [551 kPa] to the conduit or nozzle. In some embodiments, the wash water is supplied at 50-90, 60-90, 70-90 or 80-90 psig [551-621 kPa]) to the conduit or nozzle.

With reference to FIG. 5, the draining step 0822 comprises draining water from the corn of the combined batch of corn 0108 through a drain 0506 to provide drained corn.

In some embodiments, the washing does not appreciably affect a combined batch moisture concentration by weight of the corn of the combined batch of corn 0108. The temperature of the wash water can be used to provide or maintain the corn at a desired temperature. For example, the wash water 0504 can be at ambient temperature or a temperature of 10 to 26.7 or 15.6 to 26.7° C., or 21.1° C. (50 to 80 or 60 to 80° F., or 70° F.).

In some embodiments, the corn-washing step 0820 comprises washing the corn of the combined batch of corn 0108 in a washer 0502 (e.g., tumbler) for no more than about 60, 50, 40, 30, or 20 seconds.

In some embodiments, the draining step 0822 comprises draining free water (e.g., water that has not been absorbed by the corn, including wash water 0504, as applicable) from the corn of the combined batch of corn 0108. As a skilled person would understand, the draining step 0822 can comprise draining the water from the corn of the combined batch of corn 0108 along with any particles small enough to pass through a screen 0508 (e.g., drain screen) on the drain 0506. In some embodiment, the draining step 0822 comprises opening the drain to allow the water to drain from the corn of the combined batch of corn 0108 for 6-10, 7-9, or about 8 minutes.

With reference, for example, to FIG. 4, FIG. 5 and FIG. 6, the soaked-corn-conveying step 0824 comprises conveying the corn from the combined batch of corn 0108 (e.g., soaked corn, washed corn) to a mill 0602.

With reference to FIG. 6, the soaked-corn-milling step 0826 comprises milling the corn of the combined batch of corn 0108 (e.g., soaked corn, drained corn) to provide masa 0604.

In some embodiments, the soaked-corn-milling step 0826 occurs in a milling device 0606 (e.g., grinder).

In some embodiments, it can be desirable to measure a masa moisture concentration by weight of the masa 0604 exiting the milling device 0606. Among other purposes, this can be useful to confirm that the moisture concentration falls within a desired range. As examples of desired ranges, in some embodiments:
(i) the masa moisture concentration varies by no more than 1%, 0.75%, or 0.5% from a specific masa moisture concentration by weight,
(ii) the masa moisture concentration varies by no more than 2%, 1%, 0.75%, or 0.5% from 50 wt. %,
(iii) the masa moisture concentration is 48 to 52, 49 to 51 or 49.5 to 50.5 wt. %,
(iv) the masa moisture concentration changes by no more than 4, 3, 2, or 1% from a soaked corn outlet 0410 of the soak tank 0102 to an inlet 0608 to the milling device 0606, or
(v) a combination thereof.

In some embodiments, the masa moisture concentration is measured continuously or periodically using an online moisture concentration meter 0402. Although various options exist for measuring the masa moisture concentration, in some embodiments, the masa moisture concentration is measured using a meter that measures conductivity of the masa or infrared absorption and/or reflectance of the masa 0604. When one of these devices or another continuous or periodic moisture concentration meter is used, the masa moisture concentration can be measured by taking samples at regular intervals. Examples of regular intervals include 5, 4, 3, 2, or 1 minute intervals, or 30, 15, 10, 5, 4, 3, 2, or 1 second intervals.

In some embodiments, the soaked-corn-milling step 0826 involves the optional addition of water. For example, mill water 0610 can be added to the corn of the combined batch of corn 0108 during milling. In some embodiments, the mill water 0610 is provided at a controlled yet variable mill water flow rate. For example, the mill water flow rate can be varied to help control the masa 0604 temperature and the masa moisture concentration. Moreover, in some embodiments, the mill water flow rate varies within a specified range from a specified mill water flow rate, for example, within +/−10, 5, 4, 3, 2, or 1% by weight of the specified mill water flow rate.

Although not illustrated in FIG. 8, in some embodiments, the method for soaking corn further comprises transferring the masa 0604 to a production process 0612 for making a masa product 0614. Having read the present disclosure, a person having ordinary skill in the art would understand that essentially any masa product 0614 can be produced from the masa 0604 provided by the process disclosed herein.

An embodiment of a system that can be used to soak corn will now be described with reference to FIG. 1. As illustrated, the system comprises a soak tank 0102, a recirculation conduit 0140, and a recirculation conveyor 0142.

The soak tank 0102 comprises a top portion 0122, a bottom portion 0128, a sidewall 0138 extending from the bottom portion 0128 to the top portion 0122, a recirculation outlet 0120 to provide a removed stream of water 0114, a recirculation inlet 0124 to enable the removed stream of water 0114 to be reintroduced to the soak tank 0102 to provide recirculation water 0116. The top portion 0122 comprises a top 0130 of the soak tank 0102 and an upper opening 0132 for introducing corn 0110 and water 0112 into the soak tank 0102. The bottom portion 0128 comprises a bottom 0134 of the soak tank 0102 and a lower opening 0136 (e.g., provided by soaked corn outlet 0410) for discharging corn 0110 and water 0112 from the soak tank 0102.

The recirculation conduit 0140 provides fluid communication from the recirculation outlet 0120 to the recirculation inlet 0124 so the removed stream of water 0114 can be reintroduced to the soak tank 0102 through the recirculation inlet 0124 to provide the recirculation water 0116.

The recirculation conveyor 0142 (e.g., pump) is in fluid communication with the recirculation outlet 0120 and the recirculation inlet 0124. As illustrated, the recirculation conveyor 0142 is for conveying the removed stream of water 0114 to the recirculation inlet 0124 to provide the recirculation water 0116. This can be accomplished, for example, by using the recirculation conveyor 0142 to pressurize the removed stream of water 0114.

In some embodiments, the system further comprises one or more additional components. For example, as illustrated in FIG. 3, the system comprises a heater (or heater and cooler) or plurality of heaters (or plurality of heaters and coolers) for heating (or heating and cooling) corn 0110 (and optionally water 0112, lime, or a combination thereof) to provide heated corn before the corn 0110 is introduced into the soak tank 0102. It should be understood that when the term “corn” is used herein, it is also contemplated that an embodiment can be provided where the corn is present with water, lime or a combination thereof to provide a pre-masa corn mixture. For example, the use of both lime and water can be helpful to remove hulls from corn and/or provide a desired degree of hydration during soaking. Accordingly, these components can be added to the corn before it is heated, while the corn is soaking in the soak tank, during any other process steps described herein, or a combination thereof, as applicable or desired for providing a desired masa product.

As an example, with respect to FIG. 3, the system can comprise a first batch heater (or heater and cooler) 0308 for heating (or heating and cooling) a first feed batch of corn 0304 (and optionally water, lime, or a combination thereof) to provide a first heated batch of corn before the first heated batch of corn is introduced into the soak tank 0102.

Additionally, the system can comprise a second batch heater (or heater and cooler) 0310 for heating (or heating and cooling) a second feed batch of corn 0354 (and optionally water, lime, or a combination thereof) to provide a second heated batch of corn before the second heated batch of corn is introduced into the soak tank 0102.

After reading the present disclosure, a person skilled in the art would recognize that the first batch heater (or heater and cooler) 0308 and/or second batch heater (or heater and cooler) 0310 can be configured to heat (or heat and cool) product, liquid, lime or a combination thereof using many different methods and systems known in the art although all of these methods and systems are not specifically illustrated in FIG. 3. For example, combustion of a fuel (e.g., natural gas, propane, etc.), steam, hot water, hot gases (e.g., air), electric heaters, a heating jacket, a heat exchanger, microwave or radio frequency (RF) heaters, or any number of various heating techniques can be used to heat the product and/or liquid; similarly heat exchangers, ambient cooling, refrigeration, adding cooler material (e.g., cooler water) or any number of cooling techniques can be used to cool the product and/or liquid; however, in some embodiments, it can be preferable to use processing techniques (including heating or heating and cooling techniques) that avoid overly disturbing the product for example, causing the hull (e.g., pericarp) of the corn to separate from the inner portions of the corn, until the product is done absorbing liquid (e.g., soaking) or until the product is milled (e.g., ground).

In some embodiments, the system comprises a soak tank feed conveyor or plurality of soak tank feed conveyors for introducing the heated corn into the soak tank 0102. As examples, the soak tank feed conveyor can be or comprise a passive conveyor, an active conveyor, or a combination thereof. The passive conveyor and the active conveyor can be any type of passive conveyor or active conveyor described herein, respectively.

Examples of soak tank feed conveyors are illustrated in FIG. 3. As illustrated, the system comprises a first soak tank feed conveyor 0306 for introducing a first heated batch of corn into the soak tank 0102.

Additionally, the system comprises a second soak tank feed conveyor 0356 for introducing a second heated batch of corn into the soak tank 0102.

With reference to FIG. 1, the system comprises an upper closure 0144 for the upper opening 0132 and a lower closure 0146 for the lower opening 0136. For example, as illustrated in FIG. 4, the lower closure 0146 for the lower opening 0136 can be provided by a soaked corn outlet 0410.

With reference again to FIG. 1, the system comprises a screen 0118 for the recirculation outlet 0120. As illustrated, the system also comprises a discharge conduit 0148, which extends from the recirculation inlet 0124 to a recirculation discharge location 0126 where the recirculation water 0116 is discharged into the soak tank 0102.

Furthermore, in some embodiments, the system comprises soak tank insulation 0150. For example, the soak tank insulation can cover a portion of the surface of the soak tank by area, at least ¼, ⅓, ½, ⅔ or ¾ of the surface of the soak tank by area, all of the surface of the soak tank, or all of the surface area of the soak tank except for portions of the soak tank with protrusions such as instruments, inlets, outlets and valves.

With reference to FIG. 5, the system can comprise a washer feed conveyor 0510 for conveying corn discharged from the soak tank 0102 (e.g., soaked corn) to a washer 0502. The washer feed conveyor 0510 can be or can comprise a passive conveyor, an active conveyor, or a combination thereof. The passive conveyor and the active conveyor can be any type of passive conveyor or active conveyor described herein, respectively.

With reference again to FIG. 5, the system can comprise a washer 0502 (e.g., tumbler) for washing corn discharged from the soak tank 0102 (e.g., soaked corn) to provide washed corn. As illustrated, the washer 0502 comprises a hollow, cylindrically shaped tumbler 0512 and a liquid distribution system 0514. As an example, the liquid distribution system 0514 can comprise a liquid conduit 0516 with outlets 0518 (e.g., apertures or nozzles) to direct the liquid (e.g., wash water 0504) onto the product (e.g., corn) in the washer 0502. In some embodiments, the washer 0502 comprises a drain 0506 as illustrated in FIG. 5. Furthermore, in some embodiments, the washer 0502 comprises a screen 0508 (e.g., drain screen) for the drain and/or retaining the washed corn while permitting water and smaller particles of the corn (e.g., pieces of the hull) to pass through the screen.

With further reference to FIG. 5, the system can comprise a washer discharge conveyor 0520. The washer discharge conveyor 0520 can be used to convey corn (e.g., soaked corn, washed corn, and/or drained corn) discharged from the washer 0502 to a mill 0602. The washer discharge conveyor 0520 can be or can comprise a passive conveyor, an active conveyor, or a combination thereof. The passive conveyor and the active conveyor can be any type of passive conveyor or active conveyor described herein, respectively.

With reference to FIG. 6, the system can comprise a mill 0602. For example, the system or mill can comprise a milling device 0606 and/or a milling device feed conveyor 0616. The milling device feed conveyor 0616 can be or can be used in conjunction with the washer discharge conveyor 0520 to convey corn (e.g., soaked corn, washed corn, and/or drained corn) to the mill 0602. For example, the milling device feed conveyor 0616 can also convey some or all of the corn conveyed by the washer discharge conveyor 0520. As illustrated, the milling device 0606 is for grinding corn (e.g., soaked corn or washed corn) to provide a masa 0604 and the milling device feed conveyor 0616 is for conveying feed 0608 (e.g., corn, soaked corn or washed corn) to the milling device 0606. Additionally, as illustrated in FIG. 6, the mill 0602 can be configured to provide mill water 0610 to adjust the moisture concentration of the feed 0608 to the milling device 0606. For example, if a constant amount of mill water is typically added to the feed 0608 to the milling device, then if the feed is at a lower than desirable moisture concentration, the amount of mill water added to the feed can be increased. Alternatively, if the feed 0608 is at a higher than desirable moisture concentration, the amount of mill water added to the feed can be reduced, minimized or eliminated.

In some embodiments, the milling device feed conveyor 0616 is or comprises a passive conveyor, an active conveyor, or a combination thereof. The passive conveyor and the active conveyor can be any type of passive conveyor or active conveyor described herein, respectively.

As illustrated in FIG. 6, the system can also comprise a production process 0612 for making a masa product 0614 and a production process feed conveyor 0618 (e.g., conveyor, endless conveyor belt, rollers, etc.) for conveying masa 0604 to the production process 0612 for making a masa product 0614.

With reference to FIG. 1, a soak tank 0102 can comprise one or more additional features. For example, the soak tank can comprise an upper closure 0144 for the upper opening 0132; a lower closure 0146 for the lower opening 0136; a screen 0118 for the recirculation outlet 0120; a discharge conduit 0148; and soak tank insulation 0150. In some embodiments, the lower closure 0146 for the lower opening 0136 is provided by a soaked corn outlet 0410. As illustrated in FIG. 1, the discharge conduit 0148 can extend from the recirculation inlet 0124 to a recirculation discharge location 0126 where the recirculation water 0116 is discharged into the soak tank 0102.

In some embodiments, the soak tank insulation 0150 covers a portion of the surface of the soak tank by area; at least ¼, ⅓, ½, ⅔ or ¾ of the surface of the soak tank by area; all of the surface of the soak tank; or all of the surface of the soak tank, optionally, except for portions of the soak tank with protrusions such as instruments, inlets, outlets or valves.

As illustrated in FIG. 1, in some embodiments of the system, the top portion 0122 of the soak tank 0102 has a shape that is somewhat or mostly rotationally symmetric about a central axis 0152. Examples include a cylindrical shape or conical shape, with some irregularities allowable for inlets, outlets, other features or a combination thereof. Similarly, as illustrated in FIG. 1, the bottom portion 0128 of the soak tank 0102 has a shape that is somewhat or mostly rotationally symmetric about a central axis 0152. Examples include a cylindrical shape or conical shape, with some irregularities allowable for inlets, outlets, other features or a combination thereof. Moreover, as illustrated, the sidewall 0138 extends from the bottom 0134 of the soak tank 0102 to the top 0130 of the soak tank 0102.

With reference again to FIG. 1, the recirculation outlet 0120 can be provided at a location selected from the group of locations consisting of: the bottom portion 0128 of the soak tank 0102; the bottom 0134 of the soak tank 0102; the top portion 0122 of the soak tank 0102; the sidewall 0138 of the soak tank 0102; and a combination thereof.

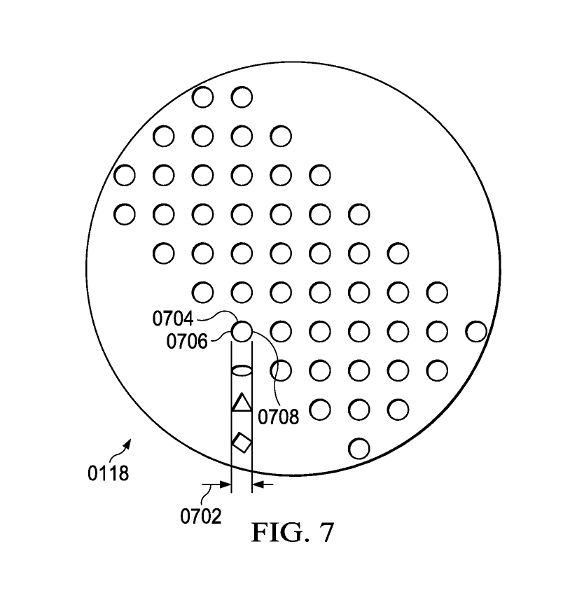

Additionally, as illustrated in FIG. 7 and FIG. 1, a screen 0118 for the recirculation outlet 0120 can be positioned at an entrance to the recirculation outlet 0120. In some embodiments, the screen 0118 for the recirculation outlet 0120 permits water to pass through the screen 0118 and through the recirculation outlet 0120. In some embodiments, the screen 0118 for the recirculation outlet 0120 is sized to retain at least 50, 75, 80, 90, 95, 96, 97, 98, or 99% by weight of solid particles of the corn in the soak tank 0102. In some embodiments, a screen 0118 for the recirculation outlet 0120 is sized to pass no more than 50, 25, 20, 10, 5, 4, 3, 2, or 1% by weight of solid particles of the corn in the soak tank 0102. In some embodiments, the recirculation inlet 0124 is located in a sidewall 0138 of a top portion 0122 of the soak tank 0102.

With reference again to FIG. 7 and FIG. 1, in some embodiments of a method or system for soaking, the soak tank 0102 comprises a screen 0118. As illustrated in

FIG. 7, the screen comprises a plurality of openings 0704 which can pass certain small particles or a liquid (e.g., water), but does not permit the passage of larger particles. For example, the screen 0118 can be for preventing solid particles of the corn in the soak tank 0102 from being carried through a recirculation outlet 0120 in the soak tank 0102 by the water in the soak tank 0102. In some embodiments, the screen 0118 is sized to retain at least 50, 75, 80, 90, 95, 96, 97, 98, or 99% by weight of solid particles of the corn in the soak tank 0102. In some embodiments, the screen 0118 is sized to pass no more than 50, 25, 20, 10, 5, 4, 3, 2, or 1% by weight of solid particles of the corn in the soak tank 0102. In some embodiments, the screen 0118 has openings 0704 for passing particles smaller than or equal to a specific size and retaining larger particles. In some embodiments, no more than 30, 25, 20, 15, 10, 9, 8, 7, 6, 5, 4, 3, 2 or 1% of the openings 0704 in the screen comprise a widest dimension 0702 equal to more than 6.35, 4.763, 3.175, 1.588, 0.794, or 0.396875 mm (¼, 3/16, ⅛, 1/16, 1/32 or 1/64 in.). Examples of a widest dimension include the longest distance between two points 0706, 0708 on the perimeter of the opening 0704, a diameter for a circle, a major axis for an ellipse, a largest diagonal for a rectangle, or a longest side for a triangle.

The percentage of openings that comprise a widest dimension equal to no more than a specific value can be calculated using various exemplary methods. One method of calculating the percentage is based on area of the openings as follows. First, a first sum equal to the sum of the open area of the openings in the screen with a widest dimension greater than the specific value can be calculated. Second, a second sum equal to the sum of the open area of all the openings in the screen can be calculated. Third, the first sum can be divided by the second sum to provide the fraction of open area pertaining to openings with a widest dimension greater than the specific value relative to the total open area of the screen. Fourth, the fraction can be converted to a percentage by multiplying the fraction by 100%.

As a further example, the percentage of openings that comprise a widest dimension equal to no more than a specific value can be calculated based on the number of openings as follows. First, a first sum equal to the number of openings in the screen with a widest dimension greater than the specific value can be calculated. Second, a second sum equal to the number of all the openings in the screen can be calculated. Third, the first sum can be divided by the second sum to provide the fraction of openings with a widest dimension greater than the specific value relative to the total openings in the screen. Fourth, the fraction can be converted to a percentage by multiplying the fraction by 100%.

In some embodiments of a method or system for soaking, the soak tank 0102 comprises a recirculation outlet 0120. In some embodiments, at least some of the water from the soak tank 0102 is removed through the recirculation outlet 0120. In some embodiments, the recirculation outlet 0120 is located no more than 30, 25, 20, 15, 10, 9, 8, 7, 6, 5, 4, 3, 2, or 1% of a height 0154 of the soak tank 0102 away from a bottom 0134 of the soak tank 0102. Additionally, in some embodiments, the recirculation outlet 0120 is located no more than 1, 0.9, 0.8, 0.7, 0.6, 0.5, 0.4, 0.3, 0.2, or 0.1 meter (3.28, 2.95, 2.62, 2.30, 1.97, 1.64, 1.31, 0.98, 0.66, 0.33 ft.) from a bottom 0134 of the soak tank 0102.

With reference again to FIG. 1, in some embodiments, the soak tank 0102 comprises a recirculation discharge location 0126. For example, as illustrated, the recirculation discharge location is where the removed stream of water 0114 is reintroduced into the soak tank 0102. Moreover, as illustrated, the recirculation discharge location 0126 is at a depth 0156 from a top 0130 of the soak tank 0102.

In some embodiments, the depth 0156 from the top 0130 of the soak tank 0102 is no more than 30, 25, 20, 15, 10, 9, 8, 7, 6, 5, 4, 3, 2, or 1% of a height 0154 of the soak tank 0102, where the height 0154 of the soak tank 0102 is measured from the top 0130 of the soak tank 0102 to a bottom 0134 of the soak tank 0102.

In some embodiments, the depth 0156 from the top 0130 of the soak tank 0102 is no more than 1.1, 1.09, 1.08, 1.07, 1.06, 1.05, 1.04, 1.03, 1.02, 1.01, or 1.0 times a depth 0158 from the top 0130 of the soak tank 0102 to an interface 0162 between a water-phase 0160 and a corn-bed-and-water-phase 0164.

In some embodiments, the depth from the top 0130 of the soak tank 0102 is no more than 1, 0.9, 0.8, 0.7, 0.6, 0.5, 0.4, 0.3, 0.2, or 0.1 meter (3.28, 2.95, 2.62, 2.30, 1.97, 1.64, 1.31, 0.98, 0.66, 0.33 ft.) from a water-air interface 0166 (e.g., water level or top surface) for the water in the soak tank 0102. Moreover, as illustrated in FIG. 1, the water-air interface 0166 can be located at a top portion 0122 of the soak tank 0102 or a top half of the soak tank 0102.

In some embodiments of a method or system for soaking, the first batch of corn 0104 has a first batch mass, the second batch of corn 0106 has a second batch mass, and the second batch mass is equal to the first batch mass +/−50%, 40%, 30%, 25%, 20%, 15%, 10%, 5%, 4%, 3%, 2% or 1% of the first batch mass.

In some embodiments, the corn of the first batch of corn 0104 has a first corn mass, the corn of the second batch of corn 0106 has a second corn mass, and the second corn mass is equal to the first corn mass +/−50%, 40%, 30%, 25%, 20%, 15%, 10%, 5%, 4%, 3%, 2% or 1% of the first corn mass.

In some embodiments, the water of the first batch of corn 0104 has a first water mass, the water of the second batch of corn 0106 has a second water mass, and the second water mass is equal to the first water mass +/−50%, 40%, 30%, 25%, 20%, 15%, 10%, 5%, 4%, 3%, 2% or 1% of the first water mass.

In some embodiments, a method or system for soaking can be used to accomplish one or more illustrative objectives, such as providing soaked corn. As an example, the soaked corn can be used for making masa 0604 as illustrated in FIG. 6. Moreover, in some embodiments, a method or system for soaking can be used for soaking corn to provide a masa 0604 with a desired masa moisture concentration and reduce or minimize variations in masa moisture concentration.

As another example, in some embodiments, the method or system for soaking is used to provide soaked corn comprising a soaked corn volume and a soaked corn moisture concentration by weight. In some embodiments, the soaked corn meets specific specifications. As a first example, the soaked corn moisture concentration can differ from a desired soaked corn moisture concentration by no more than a specified soaked corn moisture tolerance throughout the soaked corn volume. In some embodiments, the specified soaked corn moisture tolerance is 2%, 1%, 0.75%, or 0.5% of the desired soaked corn moisture concentration by weight. As an example, the desired soaked corn moisture concentration can be 50 wt. %.

With reference to FIG. 4, the method or system for soaking corn can be used to reduce or minimize a variation in the soaked corn moisture concentration throughout the soaked corn volume. The reduced or minimized variation in moisture concentration is then evident, for example, upon using a moisture concentration meter 0402 to periodically or continuously measure the soaked corn moisture concentration of a soaked corn stream (e.g., discharge stream 0404 in FIG. 4) leaving an outlet 0410 of the soak tank 0102. In some embodiments, the soaked corn moisture concentration of the soaked corn stream (e.g., discharge stream 0404) differs from a desired soaked corn moisture concentration by no more than a specified soaked corn moisture tolerance throughout the entire soaked corn volume and thus as the entire discharge stream 0404 is discharged from the soak tank. In some embodiments, the specified soaked corn moisture tolerance is 2%, 1%, 0.75%, or 0.5% of the desired soaked corn moisture concentration by weight. As an illustration, the desired soaked corn moisture concentration can be 50 wt. %. As with other measurements described herein, the measurements can be captured continuously or periodically, e.g., at regular intervals such as 5, 4, 3, 2, or 1 minute intervals or 30, 15, 10, 5, 4, 3, 2, or 1 second intervals. Additionally, a discharge temperature probe 0406 can be used to continuously or periodically measure a combined batch discharge temperature of the discharge stream 0404 to provide a plurality of periodic discharge temperature measurements at a stationary measurement point 0408.

As another example, the method or system for soaking corn can be used to provide a soaked corn moisture concentration by weight of the soaked corn throughout the soaked corn volume. In some embodiments, the soaked corn moisture concentration by weight is equal to 48 to 52 wt. %, 49 to 51 wt. %, or 49.5 to 50.5 wt. %.

With reference to FIG. 1 and FIG. 6, some embodiments comprise a method or system for soaking a plurality of heated batches of corn in the soak tank 0102 to provide a batch of masa 0604. The batch of masa 0604 comprises a masa volume and a masa moisture concentration by weight.

In some embodiments, the method or system can be used to reduce or minimize a variation in the masa moisture concentration throughout the masa volume.

In some embodiments, the masa moisture concentration by weight differs from a desired masa moisture concentration by no more than a specified masa moisture tolerance throughout the masa volume. As examples, the specified masa 0604 moisture tolerance can be 2%, 1%, 0.75%, or 0.5% of the desired masa moisture concentration by weight. In some embodiments, the desired masa moisture concentration is 50 wt. %. Additionally, the masa moisture concentration by weight of the soaked corn throughout the soaked corn volume can be 48 to 52 wt. %, 49 to 51 wt. %, or 49.5 to 50.5 wt. %.

Although the present disclosure has provided many examples of systems and methods, it should be understood that the components of the systems and method described herein are compatible and additional embodiments can be created by combining one or more elements from the various embodiments described herein. As an example, in some embodiments, a method described herein can further comprise one or more elements of a system described herein or a selected combination of elements from any combination of the systems described herein.

Furthermore, in some embodiments, a method described herein can further comprise using a system described herein, using one or more elements of a system described herein, or using a selected combination of elements from any combination of the systems described herein.

Additionally, while the present application provides multiple examples for soaking corn to form a masa, the methods and systems described herein can also be used for soaking corn for other purposes. Moreover, the methods and systems described herein can also be used for soaking other products, for example, food products, vegetables, grains, or starch-containing produce. As a further example, the methods, steps, systems, and elements described herein can be used for providing a product, with a spatial moisture concentration gradient that is limited to a desired range throughout the entire volume or mass of the product especially when the product initially has a spatial temperature gradient or spatial gradient in moisture concentration, or both. Accordingly, where the word corn is used herein, a new embodiment can be formed by replacing the word “corn” with “product” or with any product described herein. As a further example, the methods, steps, systems, and elements described herein can be used for controlling the absorption of any liquid, as opposed to only water. Accordingly, where the word “water” is used herein, a new embodiment can be formed by replacing the word water with “liquid”.

### ADDITIONAL EMBODIMENTS

The following clauses are offered as further description of the disclosed invention:

1. A method comprising:
introducing a first batch of corn into a soak tank;
introducing a second batch of corn into the soak tank to provide a combined batch of corn, wherein the combined batch of corn comprises the first batch of corn and the second batch of corn, wherein the combined batch of corn comprises corn and water, wherein the combined batch of corn comprises a combined batch volume, and wherein the combined batch of corn comprises a spatial temperature gradient within the combined batch volume; removing at least some of the water from the soak tank to provide a removed stream of water;
reintroducing the removed stream of water into the soak tank to provide recirculation water, wherein the recirculation water reduces or minimizes the spatial temperature gradient in the combined batch of corn;
discharging the combined batch of corn from the soak tank after the corn of the combined batch of corn has absorbed water to provide soaked corn.

2. The method of any preceding clause, wherein the removing at least some of the water comprises removing water from the soak tank at a bottom portion of the soak tank.

3. The method of any preceding clause, wherein the removing at least some of the water from the soak tank comprises removing at least some of the water from the soak tank through a screen (e.g., recirculation screen).

4. The method of any preceding clause, wherein the removing at least some of the water from the soak tank comprises removing at least some of the water from the soak tank through a recirculation outlet of the soak tank.

5. The method of any preceding clause, wherein the reintroducing the removed stream of water comprises reintroducing the removed stream of water into the soak tank at a top portion of the soak tank.

6. The method of any preceding clause, wherein the reintroducing the removed stream of water comprises reintroducing the removed stream of water into the soak tank though a recirculation inlet of the soak tank.

7. The method of any preceding clause, wherein the reintroducing the removed stream of water comprises reintroducing the removed stream of water into the soak tank at a recirculation discharge location.

8. The method of any preceding clause, wherein the reintroducing the removed stream of water begins after the introducing the second batch of corn into the soak tank.

9. The method of any preceding clause, wherein a recirculation delay time is the time passing from the introducing the second batch of corn into the soak tank until the reintroducing the removed stream of water into the soak tank begins, wherein a second batch delay time is the time passing from the introducing the first batch of corn into the soak tank until the introducing the second batch of corn into the soak tank, wherein the method is further characterized by an element selected from the group of elements consisting of:
(i) wherein the recirculation delay time is equal to the second batch delay time +/−50, 40, 30, 25, 20, 15, 10, 5, 4, 3, 2, or 1% of the second batch delay time;
(ii) wherein the recirculation delay time is equal to at least 1.5, 1.4, 1.3, 1.25, 1.2, 1.15, 1.1, 1.05, 1.04, 1.03, 1.02 1.01, or 1 times the second batch delay time; and
(iii) a combination thereof.

10. The method of any preceding clause, wherein the recirculation water is provided with a recirculation water flow rate, optionally wherein the method further comprises an element selected from the group of elements consisting of:
(i) wherein the recirculation water flow rate (e.g., at least 0.61, 0.46, 0.3, 0.15 m/s or 2, 1.5, 1, 0.5 ft./s) is set to provide the recirculation water with a residence time equal to no more than 18, 17, 16, 15, 14, 13, 12, 11, 10, 9, 8, 7, 6, 5, 4, 3, 2, 1, 0.5, or 0.25 hours, wherein the residence time is calculated by dividing a recirculation water mass (e.g., mass of water in the soak tank available to act as recirculation water) by a mass-based recirculation water flow rate of the recirculation water;
(iii) wherein the recirculation water flow rate is set at a value selected from the group consisting of:
   (a) no more than 1.5, 1.4, 1.3, 1.2, 1.1, 1.05, 1.04, 1.03, 1.02, 1.01 or 1.0 times a highest non-turbulent flow rate (e.g., no more than 0.61, 0.46, 0.3, 0.15 m/s or 2, 1.5, 1, 0.5 ft./s) that avoids turbulent conditions for the water in the soak tank;
   (b) no less than 0.5, 0.6, 0.7, 0.8, 0.9, 0.95, 0.96, 0.97, 0.98, 0.99 or 1.0 times a highest non-turbulent flow rate (e.g., no less than 0.61, 0.46, 0.3, 0.15 m/s or 2, 1.5, 1, 0.5 ft./s) that avoids turbulent conditions for the water in the soak tank;
   (c) no more than 1.5, 1.4, 1.3, 1.2, 1.1, 1.05, 1.04, 1.03, 1.02, 1.01 or 1.0 times a highest laminar flow rate that provides laminar conditions for the water in the soak tank;
   (d) no less than 0.5, 0.6, 0.7, 0.8, 0.9, 0.95, 0.96, 0.97, 0.98, 0.99 or 1.0 times a highest laminar flow rate that provides laminar conditions for the water in the soak tank;
   (e) a limited-Reynolds-number flow rate that provides a Reynolds number within the soak tank equal to no more than 1.0, 0.99, 0.98, 0.97, 0.96, 0.95, 0.9, 0.8, 0.7, 0.6 or 0.5 times 2300;
   (f) a limited-Reynolds-number flow rate that provides a Reynolds number within the soak tank equal to no more than 1.0, 0.99, 0.98, 0.97, 0.96, 0.95, 0.9, 0.8, 0.7, 0.6 or 0.5 times 2000;
   (g) wherein the turbulent conditions for the water in the soak tank are defined as a bulk average Reynolds number of greater than 2300 for the water located in a bed volume of the soak tank that comprises a corn-bed-and-water-phase;
   (h) wherein the laminar conditions for the water in the soak tank are defined as a bulk average Reynolds number of no more than 2000 for the water located in a bed volume of the soak tank that comprises a corn-bed-and-water-phase; and
   (i) a combination thereof;
(ii) wherein the recirculation water flow rate does not result in turbulent conditions for the water in the soak tank; and
(iv) a combination thereof.

11. The method of any preceding clause, wherein the method is further characterized by at least one element selected from the group of elements consisting of:
(i) wherein a recirculation delay time is the time passing from the introducing the second batch of corn into the soak tank until the reintroducing the removed stream of water into the soak tank begins;
(ii) wherein a second batch delay time is the time passing from the introducing the first batch of corn into the soak tank until the introducing the second batch of corn into the soak tank;
(iii) wherein the recirculation delay time is equal to at least and/or no more than 1.5, 1.4, 1.3, 1.25, 1.2, 1.15, 1.1, 1.05, 1.04, 1.03, 1.02 1.01, or 1 times the second batch delay time;
(v) wherein a second-batch time begins with the introducing the second batch of corn into the soak tank and ends with the discharging the combined batch of corn from the bottom portion of the soak tank;
(vi) wherein the recirculation water flow rate is set to provide the recirculation water with a desired residence time, wherein the residence time is calculated by dividing a recirculation water mass (e.g., unit mass of water in the soak tank available to act as recirculation water) by a mass-based recirculation water flow rate (e.g., quantified using the same unit mass), wherein the desired residence time is selected from:
   no more than and/or at least 2, 1.5, 1.25, 1.2, 1.15, 1.1, 1.05, 1, 0.95, 0.9, 0.8, 0.75, or 0.5 times the second batch delay time;
   no more than and/or at least 2, 1.5, 1.25, 1.2, 1.15, 1.1, 1.05, 1, 0.95, 0.9, 0.8, 0.75, or 0.5 times the difference of the second-batch time minus the second batch delay time;
   a residence time lower than a residence time corresponding to a recirculation water flow rate that results in turbulent conditions for the water in the soak tank; and
   a combination thereof
   and
(vii) a combination thereof.

12. The method of any preceding clause,
optionally wherein a second batch delay time is the time passing from the introducing the first batch of corn into the soak tank until the introducing the second batch of corn into the soak tank;
optionally wherein a second-batch time begins with the introducing the second batch of corn into the soak tank and ends with the discharging the combined batch of corn from a bottom portion of the soak tank,
optionally wherein a recirculation delay time is the time passing from the introducing the second batch of corn into the soak tank until the reintroducing the removed stream of water into the soak tank begins and wherein the recirculation delay time is selected from the group consisting of:
   no more than and/or at least 2.0, 1.5, 1.4, 1.3, 1.2, 1.1, 1.0, 0.9, 0.8, 0.7, 0.6, or 0.5 times the second batch delay time;
   no more than and/or at least 2.0, 1.5 to 0.5, 1.5 to 1.0, 1.0 to 0.5, 0.75 to 0.25 times the second batch delay time;
   the second batch delay time +/−50%, 40%, 30%, 20%, 10%, 5%, 4%, 3%, 2%, or 1% of the second batch delay time; and
   a combination thereof;
optionally wherein a recirculation water flow rate is set to provide the recirculation water with a desired residence time (e.g., 9-18, 10-17, 10-12, or 11 hours), wherein the desired residence time is calculated by dividing a recirculation water mass (e.g., unit mass of water in the soak tank available to act as recirculation water) by a mass-based recirculation water flow rate (e.g., quantified using the same unit mass),
optionally wherein the desired residence time is selected from the group consisting of:
   no more than and/or at least 2.0, 1.5, 1.4, 1.3, 1.2, 1.1, 1.0, 0.9, 0.8, 0.7, 0.6, or 0.5 times the difference of the second-batch time minus the second batch delay time;
   2.0, 1.5 to 0.5, 1.5 to 1.0, 1.0 to 0.5, 0.75 to 0.25 times the difference of the second-batch time minus the second batch delay time; no more than and/or at least 2.0, 1.5, 1.4, 1.3, 1.2, 1.1, 1.0, 0.9, 0.8, 0.7, 0.6, or 0.5 times the second-batch time;
   2.0, 1.5 to 0.5, 1.5 to 1.0, 1.0 to 0.5, 0.75 to 0.25 times the second-batch time;
   the second-batch time +/−50%, 40%, 30%, 20%, 10%, 5%, 4%, 3%, 2%, or 1% of the second-batch time; and
   a combination thereof; and
optionally wherein the recirculation water flow rate does not result in turbulent conditions for the water in the soak tank.

13. The method of any preceding clause, wherein the first batch of corn comprises components selected from the group consisting of corn, water, lime, and a combination thereof; optionally wherein the lime is selected from the group consisting of: calcium-containing inorganic material in which at least 50 wt. % of the material consists of a component selected from: a carbonate, an oxide, a hydroxide, and a combination thereof; calcium oxide; calcium hydroxide; and a combination thereof).

14. The method of any preceding clause, wherein the method further comprises heating (or heating and cooling) a first feed batch of corn (e.g., including any added water in the first feed batch of corn) to provide a first heated batch of corn, and wherein the first batch of corn is the first heated batch of corn or wherein the first heated batch of corn is cooled to provide the first batch of corn.

15. The method of clause 14, further characterized by at least one element selected from the group of elements consisting of:
(i) wherein the first feed batch of corn is heated from an ambient temperature (e.g., 25.0° C. (77.0° F.));
(ii) wherein the first feed batch of corn is heated (or heated and cooled) to a first preheat temperature or first initial soak temperature (e.g., to provide the first heated batch of corn), optionally wherein the method is further characterized by an element selected from the group of elements consisting of:
   (a) wherein the first preheat temperature or first initial soak temperature is equal to 37.8 to 62.8° C. (100 to 145° F.), 43.3 to 62.8° C. (110 to 145° F.), 51.7 to 62.8° C. (125 to 145° F.), 51.7 to 54.4° C. (125 to 130° F.), or 60 to 62.8° C. (140 to 145° F.) or about 61.7° C. (143° F.);
   (b) wherein the first preheat temperature or first initial soak temperature is equal to at least 37.8° C. (100° F.) and below a first gelatinization temperature at which starch in the corn will begin to gelatinize given a first feed batch preheat moisture concentration by weight of the corn of the first feed batch of corn;
   (c) wherein at least 90, 95, 96, 97, 98, or 99% by weight of the first feed batch of corn is heated (or heated and cooled) to the first preheat temperature or first initial soak temperature;
   (d) wherein the entire first feed batch of corn is heated (or heated and cooled) to the first preheat temperature or first initial soak temperature;
   (e) wherein the first preheat temperature, first initial soak temperature, or a combination thereof is a mass-weighted bulk average temperature of the first heated batch of corn; and
   (f) a combination thereof;
(iii) wherein the heating (or heating and cooling) the first feed batch of corn (e.g., to provide the first heated batch of corn) lasts no more than 0.9, 0.8, 0.7, 0.6 or 0.5 hours or wherein the heating (or heating and cooling) the first feed batch of corn lasts 0.9 to 0.3, 0.8 to 0.4, 0.7 to 0.4, 0.6 to 0.4 or about 0.5 hours;
(iv) wherein the method comprises allowing the first feed batch of corn (e.g., the first heated batch of corn) to cool to a first initial soak temperature and/or allowing the first feed batch of corn to absorb water to provide the first batch of corn with a first initial soak moisture concentration; and
(v) a combination thereof.

16. The method of any preceding clause, wherein the introducing the first batch of corn into the soak tank comprises:
introducing a first heated batch of corn into the soak tank using a first soak tank feed conveyor or introducing a first heated batch of corn into the soak tank using a first soak tank feed conveyor after the first heated batch of corn has been allowed to cool, wherein the first batch of corn is the first heated batch of corn or wherein allowing the first heated batch of corn to cool provides the first batch of corn.

17. The method of any preceding clause, wherein, upon the introducing the first batch of corn into the soak tank, the first batch of corn has a first initial soak temperature, optionally wherein the method is further characterized by an element selected from the group of elements consisting of:
(i) wherein the first initial soak temperature is equal to 37.8 to 62.8° C. (100 to 145° F.), 43.3 to 62.8° C. (110 to 145° F.), 51.7 to 62.8° C. (125 to 145° F.), 51.7 to 54.4° C. (125 to 130° F.), 48.9 to 60° C. (120 to 140° F.), or 48.9 to 54.4° C. (120 to 130° F.);
(ii) wherein the first initial soak temperature is equal to at least 37.8° C. (100° F.) and below a first gelatinization temperature at which starch in the corn will begin to gelatinize given a first batch preheat moisture concentration by weight of the corn of the first batch of corn;
(iii) wherein at least 90, 95, 96, 97, 98, 99% by weight of the first batch of corn is heated to the first initial soak temperature;
(iv) wherein the entire first batch of corn is heated or heated and cooled to the first initial soak temperature;
(v) wherein the first batch of corn is heated or heated and cooled to a mass-weighted bulk average temperature equal to the first initial soak temperature;
(vi) wherein the first initial soak temperature is the first preheat temperature; and
(vii) a combination thereof.

18. The method of any preceding clause, wherein, upon the introducing the first batch of corn into the soak tank, the first batch of corn has a first initial soak moisture concentration by weight of 30 to 38%, 31 to 37%, or 32 to 36%, 33 to 35%, or about 34%, wherein the first initial soak moisture concentration of the first batch of corn includes any inherent moisture in the corn and excludes free water around the corn, optionally wherein the first initial soak moisture concentration is measured using an online moisture concentration meter (e.g., meter with continuous monitoring capability, conductivity-based meter, infrared-based meter, etc.).

19. The method of any preceding clause, wherein the second batch of corn comprises components selected from the group consisting of corn water, lime, and a combination thereof; optionally wherein the lime is selected from the group consisting of: calcium-containing inorganic material in which at least 50 wt. % of the material consists of a component selected from: a carbonate, an oxide, a hydroxide, and a combination thereof; calcium oxide; calcium hydroxide; and a combination thereof).

20. The method of any preceding clause, wherein the method further comprises heating (or heating and cooling) a second feed batch of corn (e.g., including any added water in the second feed batch of corn) to provide a second heated batch of corn, and wherein the second batch of corn is the second heated batch of corn or wherein the second heated batch of corn is cooled to provide the second batch of corn.

21. The method of clause 20, further characterized by at least one element selected from the group of elements consisting of:
(i) wherein the second feed batch of corn is heated from ambient temperature (e.g., 25.0° C. (77.0° F.));
(ii) wherein the second feed batch of corn is heated (or heated and cooled) to a second preheat temperature (e.g., to provide the second heated batch of corn) or a second initial soak temperature, optionally wherein the method is further characterized by an element selected from the group of elements consisting of:
   (a) wherein the second preheat temperature (or second initial soak temperature) is equal to 37.8 to 62.8° C. (100 to 145° F.), 43.3 to 62.8° C. (110 to 145° F.), 51.7 to 62.8° C. (125 to 145° F.), 51.7 to 54.4° C. (125 to 130° F.), or about 61.7° C. (143° F.),
   (b) wherein the second preheat temperature (or second initial soak temperature) is equal to at least 37.8° C. (100° F.) and below a second gelatinization temperature at which starch in the corn will begin to gelatinize given a second feed batch preheat moisture concentration by weight of the second feed batch of corn;
   (c) wherein at least 90, 95, 96, 97, 98, 99% by weight of the second feed batch of corn is heated (or heated and cooled) to the second preheat temperature or second initial soak temperature,
   (d) wherein the entire second feed batch of corn is heated to the second preheat temperature,
   (e) wherein the second preheat temperature, second initial soak temperature, or a combination thereof is a mass-weighted bulk average temperature of the second heated batch of corn; and
   (f) a combination thereof;
(iii) wherein the heating (or heating and cooling) the second feed batch of corn (e.g., to provide the second heated batch of corn) lasts no more than 0.9, 0.8, 0.7, 0.6 or 0.5 hours or wherein the heating (or heating and cooling) the second feed batch of corn lasts 0.9 to 0.3, 0.8 to 0.4, 0.7 to 0.4, 0.6 to 0.4 or about 0.5 hours;
(iv) wherein the method comprises allowing the second feed batch of corn (e.g., second heated batch of corn) to cool to a second initial soak temperature and/or allowing the second batch of corn to absorb water to provide the second batch of corn with a second initial soak moisture concentration; and
(v) a combination thereof.

22. The method of any preceding clause, wherein the introducing the second batch of corn into the soak tank comprises:
introducing a second heated batch of corn into the soak tank using a second soak tank feed conveyor or introducing a second heated batch of corn into the soak tank using a second soak tank feed conveyor after the second heated batch of corn has been allowed to cool, wherein the second batch of corn is the second heated batch of corn or wherein allowing the second heated batch of corn to cool provides the second batch of corn; optionally wherein the second soak tank feed conveyor is the first soak tank feed conveyor; and optionally wherein the second soak tank feed conveyor is not the first soak tank feed conveyor.

23. The method of any preceding clause, wherein, upon the introducing the second batch of corn into the soak tank, the second batch of corn has a second initial soak temperature, optionally wherein the method is further characterized by an element selected from the group of elements consisting of:
(i) wherein the second initial soak temperature is equal to 37.8 to 62.8° C. (100 to 145° F.), 43.3 to 62.8° C. (110 to 145° F.), 51.7 to 62.8° C. (125 to 145° F.), 51.7 to 54.4° C. (125 to 130° F.), 48.9 to 60° C. (120 to 140° F.), or 48.9 to 54.4° C. (120 to 130° F.);
(ii) wherein the second initial soak temperature is equal to at least 37.8° C. (100° F.) and below a second gelatinization temperature at which starch in the corn will begin to gelatinize given a second batch preheat moisture concentration by weight of the corn of the second batch of corn;
(iii) wherein at least 90, 95, 96, 97, 98, 99% by weight of the second batch of corn is heated or heated and cooled to the second initial soak temperature;
(iv) wherein the entire second batch of corn is heated or heated and cooled to the second initial soak temperature;
(v) wherein the second batch of corn is heated or heated and cooled to a mass-weighted bulk average temperature equal to the second initial soak temperature;
(vi) wherein the second initial soak temperature is the second preheat temperature; and
(vii) a combination thereof.

24. The method of any preceding clause, wherein, upon the introducing the second batch of corn into the soak tank, the second batch of corn has a second initial soak moisture concentration by weight of 30 to 38%, 31 to 37%, or 32 to 36%, 33 to 35%, or about 34%, wherein the second initial soak moisture concentration of the corn includes any inherent moisture in the corn and excludes free water around the corn, optionally wherein the second initial soak moisture concentration is measured using an online moisture concentration meter (e.g., meter with continuous monitoring capability, conductivity-based meter, infrared-based meter, etc.).

25. The method of any preceding clause, wherein, at an initial discharge time when the discharging the combined batch of corn begins, a standard deviation of the temperature for the combined batch of corn at each spatial position in the combined batch volume in the soak tank is no more than 8.3, 5.6, 5.0, 4.4, 3.9, 3.3, 2.8, 2.2, 1.7, 1.1, 0.6, or 0.47° C. (15, 10, 9, 8, 7, 6, 5, 4, 3, 2, 1, 0.85° F.).

26. The method of any preceding clause, wherein a mass-weighted bulk average temperature of the combined batch of corn leaving the soak tank is at least 37.8° C. (100° F.) or 43.3° C. (110° F.), or is 37.8 to 54.4° C. (100 to 130° F.), 37.8 to 48.9° C. (100 to 120° F.), 43.3 to 54.4° C. (110 to 130° F.), or 48.9 to 54.4° C. (120 to 130° F.).

27. The method of any preceding clause, wherein the combined batch of corn is discharged from the soak tank to provide a discharge stream of the combined batch of corn; wherein a combined batch discharge temperature of the discharge stream is periodically (e.g., at regular intervals such as 5, 4, 3, 2, or 1 minute intervals or 30, 15, 10, 5, 4, 3, 2, or 1 second intervals) measured to provide a plurality of periodic discharge temperature measurements, optionally, for the entire combined batch of corn; wherein the combined batch discharge temperature is measured using a discharge temperature probe; wherein the discharge temperature probe is positioned to measure temperature at a stationary measurement point intersecting the discharge stream of the combined batch of corn, wherein a standard deviation of the combined batch discharge temperature for all of the plurality of periodic discharge temperature measurements is no more than 8.3, 5.6, 5.0, 4.4, 3.9, 3.3, 2.8, 2.2, 1.7, 1.1, 0.6, or 0.47° C. (15, 10, 9, 8, 7, 6, 5, 4, 3, 2, 1, 0.85° F.), optionally excluding the first 1, 2, 3, 4, or 5% by weight of the combined batch of corn to be discharged, and optionally excluding the last 1, 2, 3, 4, or 5% by weight of the combined batch of corn to be discharged.

28. The method of any preceding clause, wherein the discharging the combined batch of corn comprises discharging the combined batch of corn from a bottom portion of the soak tank, optionally, by opening the bottom portion of the soak tank to allow the combined batch of corn to exit the soak tank under a force of gravity.

29. The method of any preceding clause, wherein the discharging the combined batch of corn begins 9 to 18, 10 to 17, 10 to 12 or about 11 hours after the introducing the second batch of corn into the soak tank.

30. The method of any preceding clause, wherein the discharging the combined batch of corn takes no more than 1.5, 1, 0.5, or 0.25 hours to discharge at least 99% by weight of the combined batch of corn in the soak tank or wherein the discharging the combined batch of corn takes about 0.25 to 1.5, 0.5 to 1, or 0.4 to 0.6 hours to discharge at least 99% by weight of the combined batch of corn in the soak tank.

31. The method of any preceding clause, wherein the method further comprises:

conveying the combined batch of corn or the corn of the combined batch of corn (e.g., soaked corn) to a washer (e.g., tumbler) for washing the corn of the combined batch of corn.

32. The method of any preceding clause, wherein the method further comprises:
washing the corn of the combined batch of corn with wash water to provide washed corn, and optionally draining water from the corn of the combined batch of corn through a drain to provide drained corn, optionally wherein the wash water exits a conduit or nozzle at a high velocity (e.g., a high enough velocity to dislodge hulls of the combined batch of corn upon impact with the combined batch of corn), is supplied to the conduit or nozzle at high pressure (e.g., at least 80 psig [551 kPa] or 80-90 psig [551-621 kPa]) or a combination thereof.
optionally wherein the washed corn comprises corn kernels in which a hull (e.g., a major constituent of the corn bran) of the corn kernels has been removed from at least 50, 60, 70, 80, 90, 95, 96, 97, 98, or 99 wt. % of the corn kernels in the washed corn,
optionally the corn hull is removed in the sense that germ and endosperm corresponding to the hull is partially, mostly (e.g., at least 50, 60, 70, 80, 90, 95, 96, 97, 98, or 99 wt. %) or completely outside the hull,
optionally, wherein the washing and/or draining comprises using a screen, wherein the screen comprises openings, wherein no more than 30, 25, 20, 15, 10, 9, 8, 7, 6, 5, 4, 3, 2 or 1% (by open area of the openings or number of the openings) of the openings comprises a widest dimension (e.g., longest distance between two points on the perimeter of the opening, diameter for a circle, major axis for an ellipse, largest diagonal for a rectangle, or longest side for a triangle) equal to more than 1.58, 1.69, 1.81, 1.95, 2.12, 2.54, 2.82, 3.18, 3.63, 4.23, 4.76, 15.2, 6.35, 7.93, or 8.47 mm ( 1/16, 1/15, 1/14, 1/13, 1/12, 1/10, 1/9, ⅛, 1/7, ⅙, 3/16, ⅕, ¼, 5/16, or ⅓ in.),
optionally, wherein the washing and/or draining comprises using a screen, wherein the screen comprises openings, wherein the screen comprises openings (e.g. approximately square openings or circular openings), wherein the nominal size of the openings (e.g., side length or diameter) is contained within a range whose endpoints are selected from the group consisting of 1.58, 1.69, 1.81, 1.95, 2.12, 2.54, 2.82, 3.18, 3.63, 4.23, 4.76, 15.2, 6.35, 7.93, and 8.47 mm ( 1/16, 1/15, 1/14, 1/13, 1/12, 1/10, 1/9, ⅛, 1/7, ⅙, 3/16, ⅕, ¼, 5/16, and ⅓ in.),
optionally during washing and/or draining, small portions of the washed corn (e.g., the hulls, pieces of the hulls, or a combination thereof) pass through a screen (e.g., drain screen with approximately square openings having sides with an average length contained within a range whose endpoints are selected from the group consisting of 1.58, 1.69, 1.81, 1.95, 2.12, 2.54, 2.82, 3.18, 3.63, 4.23, 4.76, 15.2, 6.35, 7.93, and 8.47 mm ( 1/16, 1/15, 1/14, 1/13, 1/12, 1/10, 1/9, ⅛, 1/7, ⅙, 3/16, ⅕, ¼, 5/16, and ⅓ in.)) with wash water to provide drained corn, optionally wherein the drained corn comprises portions of corn kernels (e.g., endosperm and germ) retained by the screen,
optionally wherein drained corn (e.g., the portions of corn kernels retained by the screen) comprise at least 50, 60, 70, 80, 90, 95, 96, 97, 98, or 99 wt. % germ and endosperm relative to the total weight of the portions of the drained corn (e.g., the portions of the corn kernels retained by the screen).

33. The method of clause 32, further characterized by at least one element selected from the group of elements consisting of:
(i) wherein the washing does not appreciably affect a combined batch moisture concentration by weight of the corn of the combined batch of corn;
(ii) wherein the wash water is at ambient temperature or a temperature of 10 to 26.7 or 15.6 to 26.7° C., or 21.1° C. (50 to 80 or 60 to 80° F., 70° F.);
(iii) wherein the washing the corn of the combined batch of corn comprises washing the corn of the combined batch of corn in a washer (e.g., tumbler) for no more than about 60, 50, 40, 30, or 20 seconds;
(iv) wherein the draining comprises draining free water (e.g., water that has not been absorbed by the corn, including wash water, as applicable) from the corn of the combined batch of corn;
(v) wherein the draining comprises draining the water from the corn of the combined batch of corn along with any particles small enough to pass through a screen for the drain and/or retaining the washed corn while permitting water and smaller particles of the corn to pass through the screen;
(vi) wherein the draining comprises opening the drain to allow the water to drain from the corn of the combined batch of corn for 6-10, 7-9, or about 8 minutes; and
(vii) a combination thereof.

34. The method of any preceding clause, wherein the method further comprises:
conveying the corn from the combined batch of corn (e.g., soaked corn, washed corn, drained corn) to a mill.

35. The method of any preceding clause, wherein the method further comprises:
milling the corn of the combined batch of corn (e.g., soaked corn, drained corn) to provide masa.

36. The method of clause 35, further characterized by at least one element selected from the group of elements consisting of:
(i) wherein the milling the corn occurs in a milling device (e.g., grinder);
(ii) wherein a masa moisture concentration by weight of the masa exiting the milling device varies by no more than 2%, 1%, 0.75%, or 0.5% from a specific masa moisture concentration by weight;
(iii) wherein a masa moisture concentration by weight of the masa exiting the milling device varies by no more than 2%, 1%, 0.75%, or 0.5% from 50 wt. %;
(iv) wherein a masa moisture concentration by weight of the masa exiting the milling device is measured continuously or periodically (e.g., by taking samples at regular intervals such as 5, 4, 3, 2, or 1 minute intervals or 30, 15, 10, 5, 4, 3, 2, or 1 second intervals);
(v) wherein a masa moisture concentration by weight of the masa exiting the milling device is measured using an online moisture concentration meter (e.g., a meter measuring conductivity or a meter measuring infrared absorption or reflectance of the masa to determine the masa moisture concentration);
(vi) wherein a masa moisture concentration by weight of the masa at an inlet to the milling device differs by no more than 4, 3, 2, or 1% from the moisture concentration by weight of the corn from the combined batch of corn discharged from a soaked corn outlet of the soak tank (e.g., which outlet provides a lower opening in the soak tank);
(vii) wherein mill water is added to the corn of the combined batch of corn during the milling the corn, optionally:
   (a) wherein the mill water is added at a mill water flow rate, wherein the mill water flow rate is a specified mill water flow rate +/−10, 5, 4, 3, 2, or 1% by weight of the specified mill water flow rate;
   (b) wherein the mill water is provided at a controlled variable mill water flow rate (e.g., to help control the masa temperature and the masa moisture concentration); and
   (c) a combination thereof;
(viii) wherein no water is added to the corn of the combined batch of corn during the milling the corn;
(ix) wherein a masa moisture concentration by weight of the masa exiting the milling device is 48 to 52, 49 to 51, or 49.5 to 50.5 wt. %; and
(xx) a combination thereof.

37. The method of any preceding clause, wherein the method further comprises:
transferring the masa to a production process for making a masa product.

38. A system comprising:
a soak tank;
a recirculation conduit; and
a recirculation conveyor;
wherein the soak tank comprises:
   a top portion, wherein the top portion comprises a top of the soak tank and an upper opening for introducing corn and water into the soak tank;
   a bottom portion, wherein the bottom portion comprises a bottom of the soak tank and a lower opening (e.g., provided by a soaked corn outlet) for discharging corn and water from the soak tank;
   a sidewall extending from the bottom portion to the top portion;
   a recirculation outlet to provide a removed stream of water; and
   a recirculation inlet to enable the removed stream of water to be reintroduced to
the soak tank to provide recirculation water;
wherein the recirculation conduit provides fluid communication from the recirculation outlet to the recirculation inlet so the removed stream of water can be reintroduced to the soak tank through the recirculation inlet to provide the recirculation water; and
wherein the recirculation conveyor (e.g., pump) is in fluid communication with the recirculation outlet and the recirculation inlet, wherein the recirculation conveyor is for conveying the removed stream of water to the recirculation inlet to provide the recirculation water (e.g., for pressurizing the removed stream of water from the recirculation outlet).

39. The system of any preceding clause, further comprising at least one element selected from the group of elements consisting of:
a heater (or heater and cooler) or plurality of heaters (or plurality of heaters and coolers) for heating (or heating and cooling) corn (and optionally water, lime or a combination thereof, which can optionally or desirably be present with the “corn” to provide a pre-masa corn mixture) to provide heated corn before the corn is introduced into the soak tank;
a first batch heater (or first batch heater and first batch cooler) for heating (or heating and cooling) a first feed batch of corn to provide a first heated batch of corn before the first heated batch of corn is introduced into the soak tank;
a second batch heater (or second batch heater and second batch cooler) for heating (or heating and cooling) a second feed batch of corn to provide a second heated batch of corn before the second heated batch of corn is introduced into the soak tank;
a soak tank feed conveyor or plurality of soak tank feed conveyors for introducing the heated corn into the soak tank;
a first soak tank feed conveyor for introducing a first heated batch of corn into the soak tank;
a second soak tank feed conveyor for introducing a second heated batch of corn into the soak tank;
an upper closure for the upper opening;
a lower closure for the lower opening (e.g., provided by a soaked corn outlet);
a screen for the recirculation outlet;
a discharge conduit extending from the recirculation inlet to a recirculation discharge location where the recirculation water is discharged into the soak tank;
soak tank insulation (e.g., covering a portion of the surface of the soak tank by area, at least ¼, ⅓, ½, ⅔ or ¾ of the surface of the soak tank by area, or all of the surface of the soak tank optionally except for portions of the soak tank with protrusions such as instruments, inlets, outlets and valves);
a washer feed conveyor for conveying corn discharged from the soak tank (e.g., soaked corn) to a washer;
a washer (e.g., tumbler) for washing corn discharged from the soak tank (e.g., soaked corn) to provide washed corn, optionally wherein the washer comprises a drain, further optionally, wherein the washer comprises a screen for the drain and/or retaining the washed corn while permitting water and smaller particles of the corn to pass through the screen;
a milling device feed conveyor for conveying corn (e.g., soaked corn or washed corn) to a milling device;
a milling device for grinding corn (e.g., soaked corn or washed corn) to provide a masa;
a production process feed conveyor for conveying masa to a production process for making a masa product;
a production process for making a masa product; and
a combination thereof.

40. The system of any preceding clause, wherein the soak tank further comprises at least one element selected from the group of elements consisting of:
an upper closure for the upper opening;
a lower closure for the lower opening (e.g., provided by a soaked corn outlet);
a screen for the recirculation outlet;
a discharge conduit extending from the recirculation inlet to a recirculation discharge location where the recirculation water is discharged into the soak tank;
soak tank insulation (e.g., covering a portion of the surface of the soak tank by area, at least ¼, ⅓, ½, ⅔ or ¾ of the surface of the soak tank by area, or all of the surface of the soak tank optionally except for portions of the soak tank with protrusions such as instruments, inlets, outlets and valves); and
a combination thereof.

41. The system of any preceding clause, wherein the top portion of the soak tank has a shape that is somewhat or mostly rotationally symmetric about a central axis (e.g., a cylindrical shape, or conical shape, with some irregularities allowable for inlets, outlets, other features or a combination thereof).

42. The system of any preceding clause, wherein the bottom portion of the soak tank has a shape that is somewhat or mostly rotationally symmetric about a central axis (e.g., a cylindrical shape, or conical shape, with some irregularities allowable for inlets, outlets, other features or a combination thereof).

43. The system of any preceding clause, wherein the sidewall extends from the bottom of the soak tank to the top of the soak tank.

44. The system of any preceding clause, wherein the recirculation outlet is provided at a location selected from the group of locations consisting of:
the bottom portion of the soak tank;
the bottom of the soak tank;
the top portion of the soak tank;
the side wall of the soak tank; and
a combination thereof.

45. The system of any preceding clause, wherein a screen for the recirculation outlet is positioned at an entrance to the recirculation outlet.

46. The system of any preceding clause, wherein a screen for the recirculation outlet permits water to pass through the screen and through the recirculation outlet.

47. The system of any preceding clause, wherein the system is further characterized by an element selected from the group of elements consisting of:
(i) wherein a screen for the recirculation outlet is sized to retain at least 50, 75, 80, 90, 95, 96, 97, 98, or 99% by weight of solid particles of the corn in the soak tank;
(ii) wherein a screen for the recirculation outlet is sized to pass no more than 50, 25, 20, 10, 5, 4, 3, 2, or 1% by weight of solid particles of the corn in the soak tank; and
(iii) a combination thereof.

48. The system of any preceding clause, wherein the recirculation inlet is located in a sidewall of a top portion of the soak tank.

49. The method or system of any preceding clause, wherein the soak tank comprises a screen (e.g. for preventing solid particles of the corn in the soak tank from being carried through a recirculation outlet in the soak tank by the water in the soak tank), and optionally wherein the method or system is further characterized by at least one element selected from the group of elements consisting of:
(i) wherein the screen is sized to retain at least 50, 75, 80, 90, 95, 96, 97, 98, or 99% by weight of solid particles of the corn in the soak tank,
(ii) wherein the screen is sized to pass no more than 50, 25, 20, 10, 5, 4, 3, 2, or 1% by weight of solid particles of the corn in the soak tank,
(iii) wherein the screen comprises openings, wherein no more than 30, 25, 20, 15, 10, 9, 8, 7, 6, 5, 4, 3, 2 or 1% (by open area of the openings or number of the openings) of the openings comprises a widest dimension (e.g., longest distance between two points on the perimeter of the opening, diameter for a circle, major axis for an ellipse, largest diagonal for a rectangle, or longest side for a triangle) equal to more than 6.35, 15.2, 4.76, 4.23, 3.63, 3.18, 2.82, 2.54, 2.12, 1.95, 1.81, 1.69, 1.58, 0.793 or 0.396 mm (¼, ⅕, 3/16, ⅙, 1/7, ⅛, 1/9, 1/10, 1/12, 1/13, 1/14, 1/15, 1/16, 1/32 or 1/64 in.),
(iv) wherein the screen comprises openings (e.g. approximately square openings), wherein at least 50, 75, 80, 90, 95, 96, 97, 98, or 99% of the openings (by open area of the openings or number of the openings) have sides with lengths contained within a range whose endpoints are selected from the group consisting of 0.396, 0.793, 1.58, 1.69, 1.81, 1.95, 2.12, 2.54, 2.82, 3.18, 3.63, 4.23, 4.76, 15.2, and 6.35 mm ( 1/64, 1/32, 1/16, 1/15, 1/14, 1/13, 1/12, 1/10, 1/9, ⅛, 1/7, ⅙, 3/16, ⅕, and ¼ in.),
(v) wherein the screen comprises openings (e.g. approximately square openings or circular openings), wherein the nominal size of the openings (e.g., side length or diameter) is contained within a range whose endpoints are selected from the group consisting of 0.396, 0.793, 1.58, 1.69, 1.81, 1.95, 2.12, 2.54, 2.82, 3.18, 3.63, 4.23, 4.76, 15.2, and 6.35 mm ( 1/64, 1/32, 1/16, 1/15, 1/14, 1/13, 1/12, 1/10, 1/9, ⅛, 1/7, ⅙, 3/16, ⅕, and ¼ in.), and
(vi) a combination thereof.

50. The method or system of any preceding clause, wherein the soak tank comprises a recirculation outlet (e.g., for removing at least some of the water from the soak tank through the recirculation outlet); and optionally wherein the method or system is further characterized by at least one element selected from the group of elements consisting of:
(i) wherein the recirculation outlet is located no more than 30, 25, 20, 15, 10, 9, 8, 7, 6, 5, 4, 3, 2, or 1% of a height of the soak tank away from a bottom of the soak tank,
(ii) wherein the recirculation outlet is located no more than 1, 0.9, 0.8, 0.7, 0.6, 0.5, 0.4, 0.3, 0.2, or 0.1 meter (3.28, 2.95, 2.62, 2.30, 1.97, 1.64, 1.31, 0.98, 0.66, 0.33 ft.) from a bottom of the soak tank, and
(iii) a combination thereof.

51. The method or system of any preceding clause, wherein the soak tank comprises a recirculation discharge location (e.g., where the removed stream of water is reintroduced into the soak tank), optionally wherein the recirculation discharge location is at a depth from a top of the soak tank, and optionally wherein the method or system is further characterized by at least one element selected from the group of elements consisting of:
(i) the depth from the top of the soak tank is no more than 30, 25, 20, 15, 10, 9, 8, 7, 6, 5, 4, 3, 2, or 1% of a height of the soak tank, wherein the height of the soak tank is measured from the top of the soak tank to a bottom of the soak tank,
(ii) the depth from the top of the soak tank is no more than 1.1, 1.09, 1.08, 1.07, 1.06, 1.05, 1.04, 1.03, 1.02, 1.01, or 1.0 times a depth from the top of the soak tank to an interface between a water-phase and a corn-bed-and-water-phase,
(iii) the depth from the top of the soak tank is no more than 1, 0.9, 0.8, 0.7, 0.6, 0.5, 0.4, 0.3, 0.2, or 0.1 meter (3.28, 2.95, 2.62, 2.30, 1.97, 1.64, 1.31, 0.98, 0.66, 0.33 ft.) from a water-air interface for the water in the soak tank, optionally wherein the water-air interface is located at a top portion of the soak tank or a top half of the soak tank;
(iv) wherein the recirculation discharge location is at a depth from a water-air interface for the water in the soak tank, wherein the depth from the water-air interface in the soak tank is no more than 30, 25, 20, 15, 10, 9, 8, 7, 6, 5, 4, 3, 2, or 1% of the height of water in the soak tank, wherein the height of water in the soak tank is measured from the elevation of the lowest portion of water in the soak tank to the elevation of the water-air interface in the soak tank, and
(v) a combination thereof.

52. The method or system of any preceding clause, wherein the method or system further comprises an element selected from the group of elements consisting of:
wherein the first batch of corn has a first batch mass, the second batch of corn has a second batch mass, and the second batch mass is equal to the first batch mass +/−50%, 40%, 30%, 25%, 20%, 15%, 10%, 5%, 4%, 3%, 2% or 1% of the first batch mass;
wherein the corn of the first batch of corn has a first corn mass, the corn of the second batch of corn has a second corn mass, and the second corn mass is equal to the first corn mass +/−50%, 40%, 30%, 25%, 20%, 15%, 10%, 5%, 4%, 3%, 2% or 1% of the first corn mass;
wherein the water of the first batch of corn has a first water mass, the water of the second batch of corn has a second water mass, and the second water mass is equal to the first water mass +/−50%, 40%, 30%, 25%, 20%, 15%, 10%, 5%, 4%, 3%, 2% or 1% of the first water mass; and
a combination thereof.

53. The method or system of any preceding clause, wherein the method or system is for:
providing soaked corn (e.g., for masa);
soaking corn to provide a masa with a desired masa moisture concentration and reduce or minimize a variation in masa moisture concentration; or
a combination thereof.

54. The method or system of any preceding clause, wherein the method or system is for providing soaked corn comprising a soaked corn volume and a soaked corn moisture concentration by weight, optionally wherein:
(i) the soaked corn moisture concentration differs from a desired soaked corn moisture concentration by no more than a specified soaked corn moisture tolerance throughout the soaked corn volume, optionally, wherein the specified soaked corn moisture tolerance is 2%, 1%, 0.75%, or 0.5% of the desired soaked corn moisture concentration by weight, and optionally, wherein the desired soaked corn moisture concentration is 50 wt. %;
(ii) the method or system is for reducing or minimizing a variation in the corn (e.g., soaked corn) moisture concentration throughout the corn (e.g., soaked corn) volume, so that, upon periodically (e.g., at regular intervals such as 5, 4, 3, 2, or 1 minute intervals or 30, 15, 10, 5, 4, 3, 2, or 1 second intervals) or continuously measuring the corn (e.g., soaked corn) moisture concentration of a corn (e.g., soaked corn) stream (e.g., discharge stream) leaving the soak tank, the soaked corn moisture concentration of the soaked corn stream (e.g., discharge stream) differs from a desired soaked corn moisture concentration by no more than a specified soaked corn moisture tolerance throughout the soaked corn volume, optionally excluding the first 1, 2, 3, 4, or 5% by weight of the combined batch of corn to be discharged, and optionally excluding the last 1, 2, 3, 4, or 5% by weight of the combined batch of corn to be discharged, optionally wherein the specified soaked corn moisture tolerance is 5, 4, 3, 2, 1, 0.75, or 0.5% of the desired soaked corn moisture concentration by weight, and optionally, wherein the desired soaked corn moisture concentration is 50 wt. %;
(iii) wherein the soaked corn moisture concentration by weight of the soaked corn throughout the soaked corn volume is 47.5 to 52.5, 48 to 52, 49 to 51, or 49.5 to 50.5 wt. %; and
(iv) a combination thereof.

55. The method or system of any preceding clause, wherein the method or system is a method or system for soaking a plurality of heated batches of corn in the soak tank to provide a batch of masa, wherein the batch of masa comprises a masa volume and a masa moisture concentration by weight, wherein the masa moisture concentration by weight differs from a desired masa moisture concentration by no more than a specified masa moisture tolerance throughout the masa volume, optionally, wherein the specified masa moisture tolerance is 2%, 1%, 0.75%, or 0.5% of the desired masa moisture concentration by weight, optionally, wherein the desired masa moisture concentration is 50 wt. %, and optionally wherein the masa moisture concentration by weight of the soaked corn throughout the soaked corn volume is 48 to 52, 49 to 51, or 49.5 to 50.5 wt. %.

56. The method or system of any preceding clause, wherein the method or system comprises:
(i) heating the combined batch of corn in the soak tank (e.g., with a soak tank heater, which can be a recirculation water heater); so the combined batch of corn in the soak tank is provided, maintained during soaking, provided upon discharge from the soak tank, or a combination thereof, at a temperature at least as high as a desired minimum temperature (e.g., 43.3° C. (110° F.)) and/or below a temperature that results in gelatinization of the corn under the soaking conditions for the corn, for example, as provided by a first initial soak temperature range described herein; or a combination thereof);
(ii) heating the recirculation water (e.g., with a recirculation water heater); so the combined batch of corn in the soak tank is provided, maintained during soaking, provided upon discharge from the soak tank, or a combination thereof, at a temperature at least as high as a desired minimum temperature (e.g., 43.3° C. (110° F.)) and/or below a temperature that results in gelatinization of the corn under the soaking conditions for the corn, for example, as provided by a first initial soak temperature range described herein; or a combination thereof);
(iii) a soak tank heater (e.g., configured to heat the combined batch of corn in the soak tank); so the combined batch of corn in the soak tank is provided, maintained during soaking, provided upon discharge from the soak tank, or a combination thereof, at a temperature at least as high as a desired minimum temperature and/or below a temperature that results in gelatinization of the corn under the soaking conditions for the corn, for example, as provided by a first initial soak temperature range described herein; or a combination thereof);
(iv) a recirculation water heater (e.g., configured to heat at least some of the recirculation water that passes through the recirculation); so the combined batch of corn in the soak tank is provided, maintained during soaking, provided upon discharge from the soak tank, or a combination thereof, at a temperature at least as high as a desired minimum temperature (e.g., 43.3° C. (110° F.)) and/or below a temperature that results in gelatinization of the corn under the soaking conditions for the corn, for example, as provided by a first initial soak temperature range described herein; or a combination thereof); and
(v) a combination thereof.

57. The method or system of any preceding clause, wherein the method or system is a method or system for soaking a plurality of heated batches of corn in the soak tank to provide a batch of masa, wherein the batch of masa comprises a masa volume and a masa moisture concentration by weight, wherein the method or system is a method or system for reducing or minimizing a variation in the masa moisture concentration throughout the masa volume.

58. The method of any preceding method clause, wherein the method further comprises the system of any preceding system clause, wherein the method further comprises an element of the system of any preceding system clause, or wherein the method further comprises a combination of elements of the system of any preceding system clause.

59. The method of any preceding method clause, wherein the method further comprises using the system of any preceding system clause, wherein the method further comprises using an element of the system of any preceding system clause, or wherein the method further comprises using a combination of elements of the system of any preceding system clause.

60. The method of any preceding method clause, wherein the method is a method of using the system of any preceding system clause, wherein the method is a method of using an element of the system of any preceding system clause, or wherein the method is a method of using a combination of elements of the system of any preceding system clause.

61. A product (e.g., combined batch of corn, washed corn, drained corn, masa, a masa product, or combination thereof) made according to the method of any preceding method claim.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. For example, it should be understood that the method steps described herein are exemplary, and upon reading the present disclosure, a skilled person would understand that one or more method steps described herein can be combined, omitted, re-ordered, or substituted.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

Where language, for example, “for” or “to”, is used herein in conjunction with an effect, function, use or purpose, an additional embodiment can be provided by substituting “for” or “to” with “configured for/to” or “adapted for/to.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method comprising:
introducing a first batch of corn into a soak tank;
introducing a second batch of corn into the soak tank to provide a combined batch of corn, wherein the combined batch of corn comprises the first batch of corn and the second batch of corn, wherein the combined batch of corn comprises corn and water, wherein the combined batch of corn comprises a combined batch volume, and wherein the combined batch of corn comprises a spatial temperature gradient within the combined batch volume;
removing at least some of the water from the soak tank to provide a removed stream of water;
reintroducing the removed stream of water into the soak tank to provide recirculation water, wherein the recirculation water reduces the spatial temperature gradient in the combined batch of corn;
discharging the combined batch of corn from the soak tank after the corn of the combined batch of corn has absorbed water to provide soaked corn.

2. The method of claim 1, wherein the removing at least some of the water comprises removing water from the soak tank at a bottom portion of the soak tank.

3. The method of claim 1, wherein the removing at least some of the water from the soak tank comprises removing at least some of the water from the soak tank through a screen.

4. The method of claim 1, wherein the reintroducing the removed stream of water comprises reintroducing the removed stream of water into the soak tank at a top portion of the soak tank.

5. The method of claim 1, wherein the reintroducing the removed stream of water begins after the introducing the second batch of corn into the soak tank.

6. The method of claim 1, wherein a recirculation delay time is the time passing from the introducing the second batch of corn into the soak tank until the reintroducing the removed stream of water into the soak tank begins, wherein a second batch delay time is the time passing from the introducing the first batch of corn into the soak tank until the introducing the second batch of corn into the soak tank, wherein the recirculation delay time differs from the second batch delay time by no more than +1-50% of the second batch delay time.

7. The method of claim 1, wherein the recirculation water is provided with a recirculation water flow rate, wherein the recirculation water flow rate is no more than a highest non-turbulent flow rate, wherein the highest non-turbulent flow rate provides a bulk average Reynolds number of 2300 for the water located in a bed volume of the soak tank, wherein the bed volume comprises a corn-bed-and-water-phase.

8. The method of claim 1, wherein the recirculation water is provided with a recirculation water flow rate, wherein the recirculation water flow rate is no more than a highest laminar flow rate, wherein the highest laminar flow rate provides a bulk average Reynolds number of 2000 for the water located in a bed volume of the soak tank, wherein the bed volume comprises a corn-bed-and-water-phase.

9. The method of claim 1, wherein, upon the introducing the first batch of corn into the soak tank, the first batch of corn has a first initial soak temperature measured as a mass-weighted bulk average temperature of the first batch of corn, wherein the first initial soak temperature is equal to at least 37.8° C. (100° F.) and below a first gelatinization temperature at which starch in the corn will begin to gelatinize given a first batch preheat moisture concentration by weight of the corn of the first batch of corn.

10. The method of claim 1, wherein the method further comprises heating a first feed batch of corn to provide a first heated batch of corn, and wherein the first heated batch of corn provides the first batch of corn or wherein the first heated batch of corn is cooled to provide the first batch of corn; optionally, wherein the heating the first feed batch of corn lasts no more than 0.9 hours.

11. The method of claim 10, wherein the first feed batch of corn is heated to a first preheat temperature measured as a mass-weighted bulk average temperature of the first feed batch of corn; wherein the first preheat temperature is equal to at least 37.8° C. (100° F.) and below a first gelatinization temperature at which starch in the corn will begin to gelatinize given a first batch preheat moisture concentration by weight of the corn of the first batch of corn.

12. The method of claim 10, wherein the method comprises allowing the first heated batch of corn to cool to a first initial soak temperature and allowing the first batch of corn to absorb water to provide the first batch of corn with a first initial soak moisture concentration.

13. The method of claim 1, wherein, upon the introducing the second batch of corn into the soak tank, the second batch of corn has a second initial soak temperature measured as a mass-weighted bulk average temperature of the second batch of corn, wherein the second initial soak temperature is equal to at least 37.8° C. (100° F.) and below a second gelatinization temperature at which starch in the corn will begin to gelatinize given a second batch preheat moisture concentration by weight of the corn of the second batch of corn.

14. The method of claim 1, wherein, at an initial discharge time when the discharging the combined batch of corn begins, a standard deviation of the temperature for the combined batch of corn at each spatial position in the combined batch volume in the soak tank is no more than 2.8° C. (5° F.).

15. The method of claim 1, wherein the method is for reducing a variation in a moisture concentration of corn throughout a volume of the corn in a soak tank, so that, upon periodically measuring the soaked corn moisture concentration of a discharge stream leaving the soak tank, the soaked corn moisture concentration of the discharge stream differs by no more than 1% from a desired soaked corn moisture concentration equal to 50 wt. %, excluding the first 5% and last 5% by weight of the combined batch of corn to be discharged from the soak tank.

16. The method of claim 1, wherein a mass-weighted bulk average temperature of the combined batch of corn leaving the soak tank is at least 37.8° C. (100° F.).

17. The method of claim 1, wherein the combined batch of corn is discharged from the soak tank to provide a discharge stream of the combined batch of corn; wherein a combined batch discharge temperature of the discharge stream is periodically measured to provide a plurality of periodic discharge temperature measurements; wherein a standard deviation of the combined batch discharge temperature for all of the plurality of periodic discharge temperature measurements is no more than 2.8° C. (5° F.), excluding the first 5% by weight of the combined batch of corn to be discharged, and optionally excluding the last 5% by weight of the combined batch of corn to be discharged.

18. The method of claim 1, wherein the method further comprises:
conveying the corn of the combined batch of corn to a washer for washing the corn of the combined batch of corn.

19. The method of claim 1, wherein the method further comprises:
washing the corn of the combined batch of corn with wash water to provide washed corn, and optionally draining water from the corn of the combined batch of corn through a drain to provide drained corn.

20. The method of claim 1, wherein the method further comprises:
conveying the corn from the combined batch of corn to a milling device to provide a masa.

21. The method of claim 20, wherein a masa moisture concentration by weight of the masa exiting the milling device varies by no more than 2% from a specific masa moisture concentration by weight.

22. The method of claim 20, wherein a masa moisture concentration by weight of the masa at an inlet to the milling device differs by no more than 4% from the moisture concentration by weight of the corn from the combined batch of corn discharged from the soak tank.

23. The method of claim 20, wherein a masa moisture concentration by weight of the masa as it exits the milling device is 48 to 52 wt. %

24. A system comprising:
a soak tank;
a recirculation conduit; and
a recirculation conveyor;
wherein the soak tank comprises:
a top portion, wherein the top portion comprises a top of the soak tank and an upper opening for introducing corn and water into the soak tank;
a bottom portion, wherein the bottom portion comprises a bottom of the soak tank and a lower opening for discharging corn and water from the soak tank;
a sidewall extending from the bottom portion to the top portion;
a recirculation outlet to provide a removed stream of water; and
a recirculation inlet to enable the removed stream of water to be reintroduced to the soak tank to provide recirculation water;
wherein the recirculation conduit provides fluid communication from the recirculation outlet to the recirculation inlet so the removed stream of water can be reintroduced to the soak tank through the recirculation inlet to provide the recirculation water; and
wherein the recirculation conveyor is in fluid communication with the recirculation outlet and the recirculation inlet, wherein the recirculation conveyor is for conveying the removed stream of water to the recirculation inlet to provide the recirculation water.

25. The system of claim 24, wherein the system is for reducing a variation in a moisture concentration of the corn throughout a volume of the corn in the soak tank.

26. The system of claim 24, wherein the recirculation outlet is located no more than 30% of a height of the soak tank away from a bottom of the soak tank.

27. The system of claim 24, wherein the soak tank comprises a recirculation discharge location, wherein the recirculation discharge location is at a depth from a water-air interface for the water in the soak tank, wherein the depth from the water-air interface is no more than 30% of a height of the water in the soak tank, wherein the height of the water in the soak tank is measured from the elevation of the lowest portion of water in the soak tank to the water-air interface in the soak tank.

28. The system of claim 24, further comprising a heater for heating corn to provide heated corn before the corn is introduced into the soak tank.

29. The system of claim 24, further comprising a soak tank feed conveyor for introducing the heated corn into the soak tank.

30. The system of claim 24, further comprising an upper closure for the upper opening.

31. The system of claim 24, further comprising a lower closure for the lower opening.

32. The system of claim 24, further comprising a screen for the recirculation outlet.

33. The system of claim 32, wherein the screen for the recirculation outlet is sized to retain at least 90% by weight of solid particles of the corn in the soak tank.

34. The system of claim 24, further comprising a discharge conduit extending from the recirculation inlet to a recirculation discharge location where the recirculation water is discharged into the soak tank.

35. The system of claim 24, further comprising soak tank insulation.

36. The system of claim 24, further comprising a washer feed conveyor for conveying corn discharged from the soak tank to a washer.

37. The system of claim 24, further comprising a washer for washing corn discharged from the soak tank to provide washed corn.

39. The system of claim 24, further comprising a milling device feed conveyor for conveying corn to a milling device.

40. The system of claim 24, further comprising a milling device for grinding corn to provide a masa.

41. The system of claim 24, further comprising a production process feed conveyor for conveying masa to a production process for making a masa product.

42. The system of claim 24, further comprising a production process for making a masa product.

43. The system of claim 24, further comprising a recirculation water heater so the combined batch of corn in the soak tank is provided at a temperature at least as high as 43.3° C. (110° F.) and below a temperature that results in gelatinization of the corn under the soaking conditions for the corn.
